(19) United States
(12) Patent Application Publication
(10) Pub. No.: US 2026/0317848 A1
(43) Pub. Date: Oct. 15, 2026

(54) PANEL

(71) Applicant: NIPPON STEEL CORPORATION, Tokyo (JP)

(72) Inventors: Mai NAGANO, Tokyo (JP); Yasunori SAWA, Tokyo (JP); Ryuichi NISHIMURA, Tokyo (JP); Satoshi HIRONAKA, Tokyo (JP)

(73) Assignee: NIPPON STEEL CORPORATION, Tokyo (JP)

(21) Appl. No.: 19/485,636

(22) PCT Filed: May 10, 2024
(86) PCT No.: PCT/JP2024/017375

§ 371 Date: Nov. 18, 2025

(30) Foreign Application Priority Data
Aug. 29, 2023 (JP) 2023-138744

(51) Int. Cl. C21D 9/46; B62D 29/00; C21D 6/00; C21D 8/0221; C21D 8/0247; C21D 8/0278; C22C 38/00; C22C 38/02; C22C 38/04; C22C 38/06; C22C 38/12; C22C 38/26; C22C 38/28; C22C 38/32; C22C 38/38

(52) U.S. Cl. CPC C21D 9/46; C21D 6/005; C21D 6/008; C21D 8/0226; C21D 8/0236; C21D 8/0263; C21D 8/0278; C22C 38/001; C22C 38/002; C22C 38/005; C22C 38/02; C22C 38/04; C22C 38/06; C22C 38/12; C22C 38/26; C22C 38/28; C22C 38/32; C22C 38/38; B62D 29/007; C21D 2211/005; C21D 2211/008

(57) ABSTRACT

Provided is a panel comprising a steel sheet having a microstructure comprising martensite, wherein a surface texture aspect ratio Str of the steel sheet at a flat part of a center side part of the panel is 0.50 to 1.00, and a surface roughness parameter Sa of the steel sheet at the flat part of the center side part and an end part of the panel is 0.50 μm or less.

### FIELD

The present invention relates to a panel.

### BACKGROUND

In recent years, improvement of fuel efficiency of automobiles has been sought for protecting the global environment. For improvement of the fuel efficiency of automobiles, much higher strength of steel sheet for automobile is being sought for lightening the weight of car bodies while securing safety. Such a demand for higher strength is not limited to structural members such as members and pillars. Demand has also been rising for outer panels (hoods, fender panels, door panels, roof panels, etc.) of automobiles.

On the other hand, fabrication of the outer parts of automobiles has been tending to become increasingly complicated. If making a steel sheet higher in strength to make it thinner for lightening weight, asperities easily form on the surface of the steel sheets when formed into complicated shapes. If asperities are formed at the surface, the appearance after forming falls. In outer panels, not only the strength and other properties, but also the design sense and surface quality are important, and therefore excellent appearance after forming is sought.

In relation to this, PTL 1 describes an exterior panel including a steel sheet, the steel sheet including a flat portion, wherein in an outer-layer region of the flat portion, a microstructure contains, in volume fraction, ferrite of 80% or more, an average grain diameter of ferrite is 1.0 to 15.0 μm, an intensity ratio X_{ODF{001}/{111},S} between {001} orientation and {111} orientation of ferrite is 0.30 or more to less than 3.50, and when uEl₁ denotes a uniform elongation measured with a tensile test specimen cut from the flat portion, and uEl₂ denotes a theoretical uniform elongation that is derived by a predetermined formula from volume fractions, hardnesses, and average grain diameters of ferrite and martensite in a microstructure of an inside region of the flat portion, and a sheet thickness of the flat portion, uEl₁/uEl₂ is 0.44 to 0.80. Further, PTL 1 teaches that according to the above constitution, it is possible to provide an exterior panel that is excellent in surface property after the exterior panel is formed from its starting material and that is excellent in dent resistance.

PTL 2 describes a panel having a steel sheet including martensite, wherein a surface roughness parameter (Sa) at a flat part of a center-side portion of the panel is Sa≤0.500 μm; in laths of the martensite, a number density of precipitates having a major axis of 0.05 μm to 1.00 μm and an aspect ratio of 3 or more is 15 precipitates/μm² or more; and a ratio YS₁/YS₂ between a yield stress YS₁ measured in a tensile test specimen cut out from the flat part and a yield stress YS₂ measured in a tensile test specimen cut out from an end part of the panel is 0.90 to 1.10. Further, PTL 2 teaches that according to the above constitution, a panel that is excellent in both appearance after being formed from a starting material and dent resistance can be provided.

PTL 3 describes an outer plate component for an automobile, comprising a steel sheet, wherein a rolling direction of the steel sheet extends along a vehicle body left-right direction in a plan view. Further, PTL 3 teaches that it is possible to provide an outer plate component for an automobile in which ghost lines are reduced.

### CITATION LIST

### Patent Literature

[PTL 1] WO2022/004795
[PTL 2] WO2021/149810
[PTL 3] WO2023/026469

### SUMMARY

### Technical Problem

As explained above, if making a steel sheet higher in strength to make it thinner for lightening the weight, asperities easily form at the surface of the steel sheet when formed into a complicated shape and the appearance after forming declines. On the other hand, in the automobile industry, etc., further lighter weight of panels is also being sought. To achieve such lighter weight, a need arises for raising the strength more than up to now. Therefore, there continues to be a high need for a panel able to solve the problem of the appearance after forming if raising the strength equal to or more than in the past.

Therefore, the present invention has as its object the provision, by a novel configuration, of a panel excellent in appearance after forming even if made high in strength.

### Solution to Problem

The inventors engaged in studies for achieving the above object focusing in particular on the microstructure of a steel sheet for forming a panel and the surface properties of the panel. As a result, the inventors discovered that by including martensite in the microstructure of the steel sheet forming the panel, it is possible to achieve higher strength and that by suitably selecting the microstructure of the steel sheet and conditions of the press forming, etc., so that two different parameters related to the surface properties of the panel, more specifically a surface texture aspect ratio Str and surface roughness parameter Sa, are controlled to specific ranges at predetermined positions of the panel after forming, it is possible to achieve excellent appearance even in a panel made higher in strength, and thereby completed the present invention.

The present invention able to achieve the above object is as follows:
(1) A panel comprising a steel sheet having a microstructure comprising martensite, wherein
   a surface texture aspect ratio Str of the steel sheet at a flat part of a center side part of the panel is 0.50 to 1.00, and
   a surface roughness parameter Sa of the steel sheet at the flat part of the center side part and an end part of the panel is 0.50 μm or less.
(2) The panel according to the above (1), wherein a ratio of a mean KAM value/Vm of a mean KAM value of ferrite contained in the steel sheet and a volume ratio Vm of the martensite is 1.8 or more.
(3) A panel according to the above (1) or (2), wherein the steel sheet is a painted steel sheet provided with a paint layer on at least one surface.
(4) The panel according to any one of the above (1) to (3), wherein
   the microstructure of the steel sheet in the flat part comprises, by area %,
   ferrite: 75 to 95%,
   martensite: 5 to 25%, and
   at least one of bainite, pearlite, and retained austenite: 0 to 10% in total,
   a mean grain interval of martensite is 2.5 μm or less, and
   a standard deviation in an area ratio of martensite in a direction vertical to a rolling direction and sheet thickness direction is 1.5% or less.
(5) The panel according to any one of the above (1) to (4), wherein a thickness of the flat part is 0.2 to 0.8 mm.
(6) The panel according to any one of the above (1) to (5), wherein the panel has a tensile strength of 400 to 900 MPa.

### Advantageous Effects of Invention

According to the present invention, it is possible to provide a panel excellent in appearance after forming even if made high in strength.

### DESCRIPTION OF EMBODIMENTS

### <Panel>

A panel according to an embodiment of the present invention comprises a steel sheet having a microstructure comprising martensite, wherein
a surface texture aspect ratio Str of the steel sheet at a flat part of a center side part of the panel is 0.50 to 1.00, and
a surface roughness parameter Sa of the steel sheet at the flat part of the center side part and an end part of the panel is 0.50 μm or less.

As stated earlier, in recent years, the need for lighter weight has been rising for outer panels (hoods, fender panels, door panels, roof panels, etc.) For this reason, in the same way as the case of structural members, in these outer panels as well, there has been a demand for higher strength and increased thinness. On the other hand, in these outer panels, from the viewpoint of avoiding surface defects called surface strain occurring at the time of press-forming, etc., in many cases, DP (dual phase) steel with relatively low yield strength is being used. However, in the case of DP steel where soft structures comprised of ferrite and hard structures comprised of martensite are mixed, at the time of press-forming and other working, uneven deformation where the soft structures and their vicinities preferentially deform easily occurs. Fine asperities form on the panel surface after forming, whereby sometimes defects in appearance called “ghost lines” occur. Explained in more detail, at the time of press-forming and other working, the soft structures comprised of ferrite greatly deform and become recessed, while the hard structures comprised of martensite are small in amount of deformation. For this reason, the hard structures do not become as recessed as the soft structures but build up into projecting shapes. As a result, the amount of deformation varies in particular in the direction perpendicular to rolling of the panel and ghost lines are formed in band shapes (stripe shapes).

Therefore, the inventors engaged in studies to achieve both higher strength and good appearance after forming into a panel, focusing in particular on the microstructure of the steel sheet forming the panel and the surface properties of the panel. First, the inventors discovered that by including martensite in the microstructure of the steel sheet forming a panel, it is possible to achieve the desired higher strength, for example, a tensile strength of 400 MPa or more. On the other hand, the appearance after forming of a panel generally falls along with such an increase in strength, therefore the inventors engaged in further studies so as to suppress such a drop in appearance after forming focusing on the surface properties of the panel after forming. As a result, the inventors discovered that by suitably selecting the microstructure of the steel sheet and the conditions of the press-forming, etc., so that two different parameters relating to the surface properties of a panel, more specifically a surface texture aspect ratio Str and surface roughness parameter Sa, are controlled to within specific ranges at a predetermined position of the panel after forming, it is possible to achieve excellent appearance even in a panel made higher in strength.

Explained in more detail, the surface texture aspect ratio Str is known as one of the spatial parameters of the surface properties prescribed in JIS B0681-2:2018. It indicates the strength of anisotropy of the surface and takes a value of 0 to 1.00 in range. In general, the closer the value of Str to 0, the stronger the anisotropy becomes and the more streaks, etc., appear at the surface. On the other hand, the closer the value of Str to 1.00, the less the surface becomes dependent on the direction and more isotropic it becomes. The inventors discovered, as a result of studies, that if strain is imparted due to press-forming or other forming, suitably selecting the microstructure of the material of the steel sheet and the conditions of press-forming, etc., so that the surface texture aspect ratio Str of the steel sheet at a flat part at the center side part of the panel is controlled to within 0.50 to 1.00 in range is extremely effective in suppressing the formation of ghost lines at the panel surface. Ghost lines are associated with the streak patterns at the panel surface, therefore from the viewpoint of suppressing the appearance of ghost lines, the fine asperities at the panel surface are preferably more isotropic. For this reason, the value of Str is preferably closer to 1.00.

However, with just merely suitably controlling the Str, sometimes the appearance after forming cannot be sufficiently improved, therefore the inventors further studied the surface properties of panels. As a result, the inventors discovered that by controlling the surface roughness parameter Sa of the steel sheet at the flat part of the center side part and an end part of the panel to 0.50 μm or less in range in addition to suitably selecting the microstructure of the material of the steel sheet and the conditions of the press-forming, etc., to control the Str, even when strain is imparted by press-forming, etc., it is possible to remarkably suppress or reduce the occurrence of defects in appearance due to fine asperities at the panel surface. Here, the “surface roughness parameter Sa” means the average of the absolute values of z (x, y) in a reference region (A) prescribed in JIS B0681-2:2018, 4.1.7 “Arithmetical Mean Height of the Scale Limited Surface”.

Therefore, according to the panel according to an embodiment of the present invention, by sufficiently maintaining high strength based on the martensite contained in the microstructure of the steel sheet while controlling the surface properties of the panel after forming using the two different parameters of the surface texture aspect ratio Str and surface roughness parameter Sa so that the Str becomes 0.50 to 1.00 and the Sa becomes 0.50 μm or less in range, even when strain is imparted by press-forming, etc., it is possible to remarkably suppress the occurrence of ghost lines and other defects in appearance at the panel surface. In particular, the fact that even when the microstructure of the material of the steel sheet includes martensite, by controlling the surface roughness parameter Sa to 0.50 μm or less in range while making the surface texture aspect ratio Str a more isotropic surface property of 0.50 or more, it is possible to remarkably improve the appearance of the high strength panel after forming was first made clear by the present inventors. Therefore, the panel according to an embodiment of the present invention is particularly useful in applications of outer parts of automobiles where there are relatively high demands for higher strength. Below, the component elements of the panel according to an embodiment of the present invention will be explained in more detail.

### [Str of Steel Sheet at Flat Part of Center Side Part of Panel: 0.50 to 1.00]

In an embodiment of the present invention, the surface texture aspect ratio Str of the steel sheet at a flat part at the center side part of the panel after forming is controlled to 0.50 to 1.00. First, a panel according to an embodiment of the present invention includes three parts. Specifically, it includes (i) an end edge part, (ii) an end part, and (iii) a center side part other than the end edge part and end part. The end edge part of (i) is a part which is bent by hemming (HEM) or is fastened to another part by spot welding or other welding. The end part of (ii) is a part positioned at the center side of the panel from the end edge part and parts away from a part fastened to another part by hemming, welding, etc. This end part is a location several mm further separated from the end edge part, for example, toward the center of the panel and locations substantially not affected by working for fastening the panel to other parts. The “substantially not affected” in this case means the amount of change of properties due to the work for fastening the panel to other parts is within several %. The center side part of (iii) is the part recognized from the outside as the exterior, for example, the exterior of an automobile. In this Description, a location with a radius of curvature of 500 mm or more in the center side part of the panel is called a “flat part”. Further, if there is a plating layer and/or paint layer on the surface of the panel, the “flat part” means the flat part of the panel as a whole including the plating layer and/or paint layer. By controlling the surface texture aspect ratio Str at the flat part to within 0.50 to 1.00 in range, it becomes possible to obtain more isotropic surface properties and in turn becomes possible to provide a panel excellent in appearance. As stated earlier, ghost lines are associated with streak patterns on the panel surface, therefore from the viewpoint of suppression of the formation of ghost lines, it is preferable that the fine asperities at the panel surface be isotropic. Therefore, from the viewpoint of better improving the appearance after forming, the higher the Str, the more preferable. For example, it may also be 0.55 or more, 0.60 or more, 0.65 or more, 0.70 or more, 0.75 or more, or 0.80 or more. The upper limit is not particularly prescribed, but, for example, the Str may also be 0.95 or less, 0.90 or less, or 0.85 or less.

### [Measurement of Str]

The surface texture aspect ratio Str of the steel sheet at a flat part of the center side part of the panel is determined in the following way. First, a test piece is cut out from a flat part of the center side part of the panel. Next, an 8 mm×8 mm region at the surface of the cut out sample (if there is a plating layer and/or paint layer at the surface of the sample, the surface of the plating layer and/or paint layer) is three-dimensionally measured using a VK-X3000 white interferometer made by Keyence. The measurement conditions at this time are a measurement power of 10×, a resolution of the XY plane of 3 μm, a resolution of the Z spatial plane of 1 nm, and measurement consecutively. After that, this measurement region is corrected for slant by 2D curve correction and the radius of curvature of the panel as a whole is removed. Furthermore, after that, filtering is performed to eliminate asperities with a period of 0.8 mm or less and the Str is determined based on the provisions of JIS B0681-2:2018.

### [Sa of Steel Sheet at Flat Part of Center Side Part and End Part of Panel: 0.50 μm or Less]

In an embodiment of the present invention, the surface roughness parameter Sa of the steel sheet at a flat part of the center side part and an end part of the panel after forming is controlled to 0.50 μm or less. In the same way as the case of the Str, if there is a plating layer and/or paint layer on the surface of the panel, the flat part and end part mean the flat part and end part of the panel as a whole including the plating layer and/or paint layer. The surface roughness parameter Sa is the mean value of the differences of the heights of the points (absolute values) from the mean plane of the panel surface after strain is imparted at the time of forming. By controlling the surface texture aspect ratio Str explained above and additionally controlling the surface roughness parameter Sa at both of the flat part of the center side part of the panel and the end part of the panel to 0.50 μm or less, due to the effect based on the combination of the isotropic surface properties and lower surface roughness, it becomes possible to remarkably improve the appearance of the high strength panel after forming. From the viewpoint of better improving the appearance after forming, the lower the Sa, the more preferable. At each of the flat part of the center side part of the panel and the end part of the panel, for example, it may be 0.48 μm or less, 0.45 μm or less, 0.42 μm or less, 0.40 μm or less, 0.38 μm or less, or 0.35 μm or less. The lower limit is not particularly prescribed, but the Sa may, for example, be 0.05 μm or more, 0.10 μm or more, 0.15 μm or more, or 0.20 μm or more at each of the flat part of the center side part of the panel and the end part of the panel.

### [Measurement of Sa]

The surface roughness parameter Sa of the steel sheet at a flat part of the center side part and the end part of the panel is determined in the following way. First, a test piece is cut out from a flat part of the center side part of the panel. Next, an 8 mm×8 mm region at the surface of the cut out sample (if there is a plating layer and/or paint layer at the surface of the sample, the surface of the plating layer and/or paint layer) is three-dimensionally measured using a VK-X3000 white interferometer made by Keyence. The measurement conditions at this time are a measurement power of 10×, a resolution of the XY plane of 3 μm, a resolution of the Z spatial plane of 1 nm, and measurement consecutively. After that, this measurement region is corrected for slant by 2D curve correction and the radius of curvature of the panel as a whole is removed. Furthermore, after that, filtering is performed to eliminate asperities with a period of 0.8 mm or less and find the arithmetic mean height. The thus obtained arithmetic mean height is determined as the surface roughness parameter Sa of the steel sheet at the flat part of the center side part of the panel. Except for cutting out the test piece from the end part of the panel rather than the flat part of the center side part of the panel, the same procedure as above is followed to determine the surface roughness parameter Sa of the steel sheet at the end part of the panel.

### [Steel Sheet]

The panel according to an embodiment of the present invention includes a steel sheet having a microstructure containing martensite. The panel according to an embodiment of the present invention need only include at least a steel sheet having a microstructure containing martensite. The flat part of the center side part and end part of the panel formed by the steel sheet need only have the above features. Therefore, the panel according to an embodiment of the present invention may also include at least in part a material other than a steel sheet having a microstructure containing martensite. Preferably, the panel according to an embodiment of the present invention is inherently a steel sheet having a microstructure containing martensite, is comprised of the steel sheet, or is configured from the steel sheet. Martensite is a hard structure with a high dislocation density. Therefore, by including martensite in the microstructure of the steel sheet forming the panel, it becomes possible to achieve the desired increase in strength. The area ratio of martensite in the microstructure may be suitably selected in accordance with the strength of the panel sought. It is not particularly limited, but, for example, may be 5% or more, 7% or more, 10% or more, or 13% or more. Similarly, the area ratio of martensite in the microstructure may, for example, be 25% or less, 22% or less, 20% or less, 18% or less, or 15% or less. In the present invention, “martensite” is not just as-quenched martensite (so-called “fresh martensite”) and encompasses even tempered martensite.

### [Mean KAM Value/Vm: 1.8 or More]

In a preferred embodiment of the present invention, the ratio of the mean KAM value of the ferrite contained in the steel sheet forming the panel and the volume ratio Vm of the martensite: mean KAM value/Vm is controlled to 1.8 or more. The KAM (kernel average misorientation) value tends to become greater in value the more strain is built up, therefore is generally known as an effective indicator for evaluating the distribution of strain in crystal grains. On the other hand, if the ratio of martensite becomes larger, the KAM value measured tends to become larger. Therefore, by dividing the mean KAM value of ferrite contained in the steel sheet by the volume ratio Vm of martensite, it becomes possible to eliminate the effect of the martensite fraction and in that manner evaluate the degree of buildup of strain due to press-forming or other forming. In a panel applied as an outer part of an automobile, etc., it is known that the dent resistance, which expresses the resistance to recesses being formed due to stress from the outside, is also one of the several important features. To raise the dent resistance, it is effective to prevent plastic deformation from becoming harder to occur, i.e., it is effective to raise the yield stress. In relation to this, in a preferred embodiment of the present invention, it is possible to introduce a relatively high amount of strain to a panel by performing press-forming or other forming so that the mean KAM value/Vm becomes 1.8 or more. By introducing a relatively high amount of strain to a panel, it is possible to introduce a relatively large number of dislocations to the panel. As a result, it becomes possible to raise the amount of bake hardening at the time of baking on paint so as to raise the yield stress of the panel. Here, “bake hardening” is the phenomenon of penetrative type elements (mainly carbon) moving and adhering to dislocations introduced by press-forming by 100 to 220° C. paint baking treatment so that their motion is inhibited and the strength rises. This is also called “strain aging”. Due to such reasons, according to a preferred embodiment of the present invention, it becomes possible to improve the dent resistance of the panel by controlling the mean KAM value/Vm to 1.8 or more. From the viewpoint of further improving these effects, the higher the mean KAM value/Vm, the more preferable. For example, it may also be 2.0 or more, 2.5 or more, 3.0 or more, 4.0 or more, or 5.0 or more. The upper limit is not particularly prescribed, but, for example, the mean KAM value/Vm may also be 12.0 or less, 10.0 or less, or 8.0 or less.

### [Measurement of Mean KAM Value/Vm]

The mean KAM value is calculated by KAM (kernel average misorientation) analysis in the method of crystal analysis using an SEM of EBSD (electron backscatter diffraction patterns). EBSD measurement is performed in a 50 μm×50 μm range at ⅛ to ⅜ thickness centered on the ¼ position of sheet thickness from the surface of the steel sheet at 0.05 μm intervals (pitch). At this time, the KAM analysis finds the average of the misorientation of six pixels adjoining a certain single pixel of a measurement point and defines it as the value of the center pixel. It is possible to prepare a map based on the local crystal misorientation. Vm is the volume ratio of a GAIQ (grain average image quality) of 4000 or more in EBSD measurement obtained by the same measurement conditions as the mean KAM value. At this time, GAIQ analysis finds the average in one crystal grain boundary of the IQ values expressing the clearest of the Kikuchi patterns of one pixel at the measurement point when defining a region with a crystal orientation differing by 15° or more as a crystal grain boundary (grain) and defines this as the value of the center pixel. Using the difference in clearness of the Kikuchi patterns, it is possible to prepare a phase map of ferrite and martensite using the crystal grain boundaries as interfaces. The thus obtained KAM map and phase map are compared against each other to calculate the mean KAM value at the regions corresponding to ferrite. Furthermore, this mean KAM value can be divided by Vm to calculate the mean KAM value/Vm at one field. This operation is performed for five fields and the mean value is made the mean KAM value/Vm.

### [Paint Layer]

In the panel according to an embodiment of the present invention, the steel sheet may either not be provided with a paint layer or may be a painted steel sheet provided with a paint layer on at least one surface. For example, if the surface properties of the panel are not good, to obtain a beautiful appearance, it becomes necessary to thickly apply a paint layer. However, the panel according to an embodiment of the present invention is excellent in surface properties, therefore the paint layer can be made thin. For this reason, this is extremely advantageous from the cost perspective. In addition, in relation to the bake hardening at the time of baking on the paint, it is possible to raise the yield stress of the panel. For this reason, this is also advantageous from the viewpoint of improvement of the dent resistance of the panel. If applying a steel sheet having a microstructure in which martensite is finely and uniformly dispersed overall, as explained later in relation to a preferred embodiment of the steel sheet, it is possible to remarkably raise the amount of bake hardening due to the uniform dispersion of martensite containing a relatively large amount of dislocations. Therefore, the yield stress can be similarly remarkably raised, therefore the dent resistance of the panel can be further improved.

If the steel sheet is provided with a plating layer, the paint layer can be formed on the plating layer. The paint layer is not particularly limited and may be any suitable paint layer known to persons skilled in the art. The coat thickness of the paint layer is also not particularly limited and may, for example, be 60 to 200 μm. The paint layer in panels for automobile generally include, in order from the steel sheet side, an electrodeposition paint layer, intermediate coat paint layer, base coat layer, and clear coat layer. The thickness of the electrodeposition paint layer may, for example, be 10 to 40 μm. The thickness of the intermediate coat paint layer may, for example, be 20 to 60 μm. Similarly, the thickness of the base coat layer may, for example, be 10 to 30 μm and the thickness of the clear coat layer may, for example, be 20 to 80 μm.

### [Preferable Embodiment of Steel Sheet]

Below, a preferable embodiment of a steel sheet having a microstructure containing martensite, which steel sheet is useful for realizing surface properties of the panel of a surface texture aspect ratio Str of the steel sheet at a flat part of the center side part of 0.50 to 1.00 and a surface roughness parameter Sa of the steel sheet at a flat part of the center side part and end part of 0.50 μm or less when formed by press-forming, etc., will be explained in detail. However, the explanation is intended as merely an illustration of the preferred chemical composition of a steel sheet forming the panel according to an embodiment of the present invention and is not intended to limit the present invention to an embodiment using such a specific steel sheet.

In a preferred embodiment of the present invention, the steel sheet has a microstructure at a flat part of a center side part of the panel comprised of, by area %,
ferrite: 75 to 95%,
martensite: 5 to 25%, and
at least one of bainite, pearlite, and retained austenite: 0 to 10% in total,
having a mean grain interval of martensite of 2.5 μm or less, and
having a standard deviation in an area ratio of martensite in a direction vertical to the rolling direction and sheet thickness direction of 1.5% or less.

As stated above, in the case of DP steel in which soft structures comprised of ferrite and hard structures comprised of martensite are mixed, uneven deformation where the soft structures and their vicinities deform preferentially at the time of press-forming and other working easily occurs resulting in formation of fine asperities at the panel surface after forming and thereby the formation of defects in appearance called ghost lines. On the other hand, along with the increase in strength of a steel sheet, sometimes Mn and other elements are added in relatively large amounts to improve the hardenability of the steel sheet. Mn is an element which easily segregates in streak shapes in a steel sheet. More specifically, at the time of casting, Mn concentrated regions called center segregation or microsegregation are formed. These concentrated regions are stretched in the rolling direction by hot rolling or cold rolling whereby Mn segregates in streak shapes. For this reason, due to such segregation of Mn, regions with high hardenability and regions with low ones are present in the steel sheet. As a result, a relatively large amount of stripe shaped hard structures are formed in the microstructure of the steel sheet after hardening. In this case, ghost lines are particularly remarkably formed. As opposed to this, if it were possible to sufficient suppress Mn segregation in a steel sheet, it would become possible to reduce the formation of such stripe shaped hard structures and make the hard structures uniformly disperse in the microstructure. In such a case, even if strain is imparted due to press-forming, etc., it is believed possible to realize surface properties of the panel of a surface texture aspect ratio Str of the steel sheet at a flat part of the center side part of 0.50 to 1.00 and a surface roughness parameter Sa of the steel sheet at the flat part of the center side part and end part of 0.50 μm or less. Further, in relation to this, it is believed that it becomes possible to sufficiently reduce the formation of fine asperities at the panel surface and possible to suppress the formation of ghost lines. However, along with the demand for higher strength, in particular if the amount Mn added in the steel sheet becomes greater, in actuality, it is extremely difficult to reliably and sufficiently suppress Mn segregation.

Therefore, the inventors studied means for realizing the desired higher strength while furthermore improving the appearance after forming by suitably adjusting the ratio of the soft structures of ferrite and the hard structures of martensite in the microstructure. Specifically, the inventors engaged in studies focusing on the state of distribution of the hard structures of martensite in the microstructure, more specifically control of the distribution of martensite, from a separate viewpoint different from reduction of the Mn segregation. As a result, as explained in detail later regarding the method of production of a steel sheet, the inventors discovered that by forming the microstructure in the steel sheet before the final annealing by structures mainly comprised of bainite and/or martensite and then final annealing the steel sheet having such a microstructure under predetermined conditions, it is possible to make martensite uniformly disperse in the finally obtained microstructure in both the microregions and macroregions without necessarily relying on the presence or extent of Mn segregation. More specifically, the inventors discovered that by final annealing steel sheet having a microstructure comprised of bainite and/or martensite under predetermined conditions, it is possible to control the mean grain interval of martensite to 2.5 μm or less in the microregions and possible to control the standard deviation in the area ratio of martensite in a direction vertical to the rolling direction and sheet thickness direction to 1.5% or less in the macroregions. By controlling the mean grain interval of martensite to 2.5 μm or less, it is possible to make the hard structures densely and uniformly disperse in the microregions. In addition, by controlling the standard deviation in the area ratio of martensite in a direction vertical to the rolling direction and sheet thickness direction to 1.5% or less, it is possible to remarkably reduce the variation in hard structures in the macroregions. By satisfying both of these requirements, it is possible to form a microstructure in which the hard structures of martensite are finely and uniformly dispersed in the steel sheet as a whole. As a result, according to a preferred embodiment of the present invention, it is possible to make the amount of deformation of the steel sheet more uniform in particular in the width direction even at the time of press-forming or other forming. In relation to this, by realizing surface properties of a panel having the desired Str and Sa, it becomes possible to achieve an excellent appearance after forming in which ghost lines and other defects in appearance are remarkably suppressed. For example, even if uniformity of martensite is secured in the microregions, unless uniformity of martensite is secured in the macroregions, it is not possible to form a microstructure in which martensite is finely and uniformly dispersed in the steel sheet as a whole. Similarly, even if uniformity of martensite is secured in the macroregions, unless uniformity of martensite is secured in the microregions, locally there may be martensite present nonuniformly, therefore it is not possible to form a microstructure in which martensite is finely and uniformly dispersed in the steel sheet as a whole. Therefore, in a preferred embodiment of the present invention, to achieve excellent appearance after forming in which ghost lines and other defects in appearance are remarkably suppressed, it becomes necessary to satisfy both the requirements of control of the mean grain interval of martensite to 2.5 μm or less and control of the standard deviation in the area ratio of martensite in a direction vertical to the rolling direction and sheet thickness direction to 1.5% or less.

While not intending to be bound by any specific theory, to make martensite finely and uniformly disperse in a steel sheet as a whole in the finally obtained microstructure of the steel sheet, it is believed that forming a large number of austenite nuclei forming sites in a high dispersion at the time of the heating in the final annealing is extremely important. In relation to this, martensite structures further have packets, blocks, laths, and other substructures in the former austenite grains, therefore are structures having a larger number of diverse interfaces inside them compared with ferrite and other structures. Bainite is also a structure having a large number of diverse interfaces inside in the same way as the case of martensite. Therefore, by forming the microstructure in the steel sheet before the final annealing by bainite and/or martensite, it becomes possible to form an extremely large number of carbides able to form austenite nuclei forming sites dispersed on the interfaces at the stage of heating such a microstructure in the final annealing. Therefore, by it is believed that by heating the temperature to the dual phase region of ferrite and austenite after forming a large number of carbides on the interfaces, it becomes possible to form austenite finely and uniformly at the steel sheet as a whole. Finally, the steel sheet having such a microstructure is rapidly cooled to form martensite from the austenite, therefore in the finally obtained microstructure, the mean grain interval of the martensite is controlled to 2.5 μm or less and the standard deviation in the area ratio of martensite in a direction vertical to the rolling direction and sheet thickness direction is controlled to 1.5% or less. That is, it is believed possible to obtain a microstructure in which martensite is uniformly dispersed in both the microregions and macroregions. By performing such heat treatment, it is believed possible to make the martensite finely and uniformly disperse over the steel sheet as a whole so much as to cancel out the effect of Mn segregation. In the past, it had generally been considered to study control of the distribution of hard structures from the viewpoint of reducing Mn segregation itself, therefore the fact that it is possible to make martensite uniformly disperse in both the microregions and microregions of the finally obtained microstructure without necessarily relying on the presence or degree of Mn segregation is extremely unexpected and should be surprising.

According to a preferred embodiment of the present invention, in addition to the above discovery relating to the suppression of formation of ghost lines, by controlling the area ratio of the soft structures of ferrite to 75 to 95%, it is possible to secure good formability and by controlling the area ratio of the hard structures of martensite to 5 to 25% and, further, controlling the chemical composition of the steel sheet to within predetermined ranges, it becomes possible to reliably achieve high strength, for example, high strength of a tensile strength of 400 MPa or more. As a result, it becomes possible to realize higher strength and good appearance after forming into a panel at high levels. In addition, the steel sheet according to a preferred embodiment of the present invention, as explained above, has a microstructure in which martensite is dispersed finely and uniformly in its entirety, therefore in the paint baking after forming into a panel, it is possible to remarkably raise the amount of bake hardening due to the uniform dispersion of the martensite which includes relatively large amounts of dislocations. Therefore, by using this steel sheet, it is possible to remarkably raise the yield stress of the obtained panel. Therefore, this is extremely advantageous also from the viewpoint of improving the dent resistance of the panel.

Below, first, the microstructure of the steel sheet according to a preferred embodiment of the present invention will be explained in further detail. The structural fractions are displayed by area ratios, therefore the unit “%” of the structural fractions means area %. Further, the microstructure of the steel sheet means the microstructure of the steel sheet at a flat part of a center side part of the panel. At the flat part, the extent of forming is low and therefore the features of the microstructure shown below do not particularly change before and after press-forming and other working.

### [Ferrite: 75 to 95%]

Ferrite is a soft structure, therefore easily deforms and contributes to improvement of elongation. If the area ratio of ferrite is 75% or more, sufficient formability can be obtained. From the viewpoint of improvement of formability, the higher the area ratio of ferrite, the more preferable. For example, it may be 78% or more, 80% or more, 82% or more, or 85% or more. On the other hand, if excessively including ferrite, sometimes it is not possible to achieve the desired strength at the steel sheet. Therefore, the area ratio of ferrite is made 95% or less. The area ratio of ferrite may also be 93% or less, 90% or less, or 87% or less.

### [Martensite: 5 to 25%]

Martensite is high in dislocation density and a hard structure, therefore is a structure contributing to improvement of the tensile strength. By making the area ratio of martensite 5% or more, for example, it is possible to achieve a tensile strength of 400 MPa or more. From the viewpoint of improvement of the strength, the higher the area ratio of martensite, the more preferable. For example, it may be 7% or more, 10% or more, or 13% or more. On the other hand, if the area ratio of martensite is 25% or less, formability and appearance can be secured. The area ratio of martensite may also be 22% or less, 20% or less, 18% or less, or 15% or less.

### [At Least One of Bainite, Pearlite, and Retained Austenite: Total of 0 to 10%]

The balance structures besides the ferrite and martensite may be an area ratio of 0%, but if there are balance structures, the balance structures include at least one of bainite, pearlite, and retained austenite. From the viewpoint of securing the above effect based on ferrite and martensite, the area ratio of the balance structures, i.e., at least one of bainite, pearlite, and retained austenite, is a total of 10% or less, for example, may be 9% or less, 8% or less, 7% or less, 6% or less, 5% or less, 4% or less, or 2% or less. On the other hand, to make the area ratio of the balance structures 0%, a high degree of control is required in the process of production of the steel sheet, therefore sometimes a drop in the yield is sometimes invited. Therefore, the area ratio of the balance structures may be 0.5% or more or 1% or more.

### [Identification of Microstructure and Calculation of Area Ratios]

The microstructure is identified and the area ratios are calculated by an FE-SEM (field emission type scan electron microscope) and optical microscope and X-ray diffraction after corrosion using a Nital solution or LePera's reagent. The structure is observed by the FE-SEM and optical microscope at a power of 1000 to 50000× at a 100 μm×100 μm region at the steel sheet cross-section in a direction vertical to the sheet surface. At each microstructure, three locations are measured. The mean value of these measured values is calculated to determine the area ratio. For example, if the sheet thickness is thin and therefore it is not possible to secure a 100 μm measurement region in the sheet thickness direction, the length in the sheet thickness direction is shortened while securing an observed area of 10000 μm². The same is true for the “100 μm×100 μm region” in the following explanation.

The area ratio of ferrite is found by examining a 100 μm×100 μm region at sheet thickness ⅛ to ⅜ in range centered at sheet thickness ¼ in an electron channeling contrast image by an FE-SEM (field emission type scan electron microscope). More specifically, the image analysis software Image J is used to binarize the ferrite and martensite by the differences in brightness and calculate the area ratio of ferrite. If using LePera's reagent, the black parts of the image data are ferrite while the white parts are martensite and retained austenite.

The area ratio of martensite is found by the following procedure. First, the examined surface of the sample is etched by LePera's reagent, then a 100 μm×100 μm region at sheet thickness ⅛ to ⅜ in range centered at sheet thickness ¼ is examined by an FE-SEM. With LePera corrosion, the martensite and retained austenite are not corroded, therefore the area ratio of the region not corroded corresponds to the total area ratio of martensite and retained austenite. The area ratio of martensite is calculated by subtracting from the area ratio of the not corroded region the area ratio of retained austenite measured by X-ray diffraction explained later.

The area ratio of retained austenite is calculated by X-ray diffraction. First, the material from the sheet surface of the sample down to the depth ¼ position in the sheet thickness direction is removed by mechanical polishing and chemical polishing. Next, the structural fraction of the retained austenite is calculated from the integrated intensity ratio of the diffraction peaks of (200) and (211) of the bcc phase and (200), (220), and (311) of the fcc phase obtained using MoKα rays at the sheet thickness ¼ position. As the method of calculation the general five peak method is utilized. The structural fraction of the retained austenite calculated is determined as the area ratio of the retained austenite.

Bainite is identified and its area ratio is calculated by the following procedure. First, the examined surface of the sample is corroded by a Nital solution, then a 100 μm×100 μm region at sheet thickness ⅛ to ⅜ in range centered at sheet thickness ¼ is examined by an FE-SEM. Bainite is identified in the following way from the positions of cementite and arrangement of cementite contained in the structures in the examined region. Bainite is classified as upper bainite and lower bainite. Upper bainite has cementite or retained austenite present at the interfaces of the lath shaped bainitic ferrite. Lower bainite has cementite present inside the lath shaped bainitic ferrite. There is one type of relationship of crystal orientation of bainitic ferrite and cementite. Cementite has the same variants. It is possible to identify upper bainite and lower bainite based on these features. In the present invention, these are together called “bainite”. The area ratio of the identified bainite is calculated by image analysis.

Pearlite is identified and its area ratio is calculated by the following procedure. First, the observed surface of a sample is corroded by a Nital reagent, then the range of sheet thickness ⅛ to ⅜ centered about sheet thickness ¼ is examined by an optical microscope at a power of 500× or 1000×. Regions with dark contrast in the observed images of the optical microscope are identified as pearlite. The area ratios of the regions are calculated by image analysis.

### [Mean Grain Interval of Martensite: 2.5 μm or Less]

In a preferred embodiment of the present invention, the mean grain interval of the hard structures of martensite is controlled to 2.5 μm or less. The mean grain interval of martensite is an indicator expressing the uniformity of distribution of hard structures in microregions. The smaller the mean grain interval of martensite, the denser and more uniformly dispersed the hard structures is meant. Accordingly, the uniformity can be said to be high. The appearance after press-forming becomes better the more uniform the amount of deformation of the steel sheet at the time of press-forming, in particular in the width direction of the steel sheet. The amount of deformation of steel sheet is strongly affected by the state of distribution of the hard structures, therefore to make the amount of deformation of steel sheet uniform in the width direction of the steel sheet, it is necessary to make the distribution of hard structures in the microstructure uniform. By controlling the mean grain interval of martensite to 2.5 μm or less in addition to control of the standard deviation of the area ratio of martensite explained later, it is possible to make the amount of deformation of steel sheet more uniform in the width direction even at the time of press-forming or other forming and as a result it is possible to achieve excellent appearance after forming. The mean grain interval of martensite is preferably 2.4 μm or less, more preferably 2.2 μm or less, most preferably 2.0 μm or less or 1.8 μm or less. The lower limit is not particularly prescribed, but, for example, the mean grain interval of martensite may also be 0.5 μm or more, 0.8 μm or more, or 1.0 μm or more.

### [Measurement of Mean Grain Interval of Martensite]

The mean grain interval of martensite is determined in the following way. First, a sample having a steel sheet cross-section in a direction vertical to the sheet surface is taken. The cross-section is made the examined surface. In the examined surface, a 100 μm×100 μm region at sheet thickness ⅛ to ⅜ in range centered at sheet thickness ¼ is used as the examined region. An FE-SEM is used to identify the martensite. Specifically, the image analysis software Image J is used to binarize the ferrite and martensite by the differences in brightness and identify the martensite. If using LePera's reagent, the black parts of the image data are ferrite while the white parts not corroded by LePera's reagent are the total structures of martensite and retained austenite. In the steel sheet according to a preferable embodiment of the present invention, the area ratio of the retained austenite is sufficiently lower compared with the area ratio of martensite, therefore the white structures can be deemed to be martensite. Next, in the identified martensite, the distances between the centers (centers of gravity) of all adjoining martensite grains are calculated as grain spacings by image analysis. The mean value of the calculated grain spacings is determined as the mean grain interval of the martensite (strictly speaking, grains including martensite and/or retained austenite).

### [Standard Deviation in Area Ratio of Martensite in Direction Vertical to Rolling Direction and Sheet Thickness Direction of 1.5% or Less]

In a preferred embodiment of the present invention, the standard deviation in an area ratio of martensite in a direction vertical to the rolling direction and sheet thickness direction is controlled to 1.5% or less. The standard deviation is an indicator expressing the uniformity of hard structures in the macroregions. The outer appearance, which becomes an issue at the time of press-forming, is dependent on the fine asperities at the steel sheet surface due to the difference in amounts of deformation in the width direction of the steel sheet. For this reason, if the variation in area ratio of hard structures contained in the sheet thickness in a direction vertical to the rolling direction and sheet thickness direction is large, differences will arise in the amount of deformation in the width direction of the steel sheet and as a result fine asperities will form at the steel sheet surface. Therefore, it is effective to reduce the standard deviation in an area ratio of martensite in a direction vertical to the rolling direction and sheet thickness direction, i.e., the width direction of the steel sheet. More specifically, by controlling the standard deviation to 1.5% or less in addition to controlling the mean grain interval of martensite explained previously, it is possible to reduce more the variation in amount of deformation of a steel sheet in the width direction even at the time of press-forming or other forming and as a result it is possible to achieve excellent appearance after forming. The standard deviation in an area ratio of martensite in a direction vertical to the rolling direction and sheet thickness direction is preferably 1.4% or less, more preferably 1.2% or less, most preferably 1.0% or less. The lower limit is not particularly prescribed, but, for example, the standard deviation may also be 0.1% or more, 0.3% or more, or 0.5% or more.

### [Measurement of Standard Deviation in Area Ratio of Martensite in Direction Vertical to Rolling Direction and Sheet Thickness Direction]

The standard deviation in an area ratio of martensite in a direction vertical to the rolling direction and sheet thickness direction is determined in the following way. First, an image of the microstructure in a steel sheet cross-section of a 50 mm region in a direction vertical to the rolling direction and sheet thickness direction is obtained. In the case of an image of 10 mm or smaller, a plurality of images can be obtained and stitched together to obtain 50 mm. If the rolling direction is unclear, the cross-section is examined in orientations of 0°, 45°, 90°, and 135° with respect to any direction, the cross-section with the highest aspect ratio of the precipitates among them is deemed a cross-section parallel to the rolling direction and the direction vertical to this is identified as the direction vertical to the rolling direction and sheet thickness direction. Next, the obtained image is divided into 100 μm (0.1 mm) ranges in a direction vertical to the rolling direction and the area ratio of martensite in the sheet thickness as a whole is calculated in each divided range. The standard deviation in the area ratio of martensite is calculated based on the martensite area ratios calculated from a total of 500 divided images. The operation is performed for three regions at different positions in the rolling direction. The mean value of the standard deviations found respectively is determined as the standard deviation in an area ratio of martensite in a direction vertical to the rolling direction and sheet thickness direction.

If the rolling direction of the steel sheet is not clear, for example, the following method is employed as the method for identifying the rolling direction of the steel sheet. A sheet thickness cross-section of the steel sheet is finished by polishing it to a mirror surface, then the S concentration is measured by an electron probe micro analyzer (EPMA). The measurement conditions are made an acceleration voltage of 15 kV and a measurement pitch of 1 μm. An image of the distribution in a range of 100 μm (sheet thickness direction)×500 μm (direction vertical to sheet thickness direction) at the sheet thickness center part is measured. At this time, a stretched region with a high S concentration is judged as MnS or another inclusion. At the time of examination, several fields may also be examined. Next, based on the sheet thickness cross-section first examined by the above method, the surfaces parallel to the surfaces rotated at 5° increments in the 0° to 180° range about the sheet thickness direction are examined in cross-section by the above method. The mean value of the lengths of the long axes of the pluralities of inclusions at the obtained cross-sections is calculated for each cross-section and the cross-section with the largest mean value of lengths of long axes of inclusions is identified. The direction parallel to the long axis direction of the inclusions at that cross-section is judged to be the rolling direction.

[Mean Grain Size of Ferrite: 3.0 to 25.0 μm]

According to another preferred embodiment of the present invention, the mean grain size of the ferrite in the microstructure is 3.0 to 25.0 μm. By controlling the main grain size of the ferrite to within such a fine range, it becomes possible to further improve the appearance of the panel after forming. The mean grain size of ferrite may also be 5.0 μm or more, 7.0 μm or more, 8.0 μm or more, 9.0 μm or more, or 10.0 μm or more. Similarly, the mean grain size of ferrite may also be 22.0 μm or less, 20.0 μm or less, 16.0 μm or less, 14.0 μm or less, or 12.0 μm or less.

The mean grain size of ferrite in the steel sheet is determined in the following way. First, in a steel sheet etched by LePera's reagent, 10 fields are examined by a power of 500× or 1000× in a region of sheet thickness ½ position from the surface in the sheet thickness direction. Image analysis software of “Photoshop® CS5” made by Adobe is used to analyze the images and calculate the area ratios of the ferrite and the number of grains of ferrite in each field. Next, the area ratios of ferrite and the number of grains of ferrite in the 10 fields are totaled up and the total area ratio of ferrite is divided by the total number of grains of ferrite to calculate the mean area ratio per ferrite grain. The circle equivalent diameter is calculated from the mean area ratio and number of grains and the obtained circle equivalent diameter is determined as the mean grain size of the ferrite. The observed area is made 150 μm in the sheet thickness direction and 250 μm in a direction vertical to the sheet thickness direction (the observed area in this case being 150×250=37500 μm²). For example, if sheet thickness is thin and therefore it is not possible to secure a 150 μm measurement region in the sheet thickness direction, the length in the sheet thickness direction is shortened while securing an observed area of 37500 μm². The same is true for the method of determination of the mean grain size of martensite and the mean aspect ratio of martensite.

[Mean Grain Size of Martensite: 1.0 to 5.0 μm]

According to another preferred embodiment of the present invention, the mean grain size of the martensite in the microstructure is 1.0 to 5.0 μm. By controlling the main grain size of the martensite to within such a fine range, it becomes possible to further improve the appearance of the panel after forming. The mean grain size of martensite may be 1.2 μm or more, 1.5 μm or more, 1.7 μm or more, or 2.0 μm or more. Similarly, the mean grain size of martensite may also be 4.7 μm or less, 4.5 μm or less, 4.2 μm or less, 4.0 μm or less, 3.8 μm or less, 3.6 μm or less, or 3.4 μm or less.

The mean grain size of martensite is determined in the following way. First, in a steel sheet etched by LePera's reagent, 10 fields are examined by a power of 500× or 1000× in a region of sheet thickness ½ position from the surface in the sheet thickness direction. Image analysis software of “Photoshop® CS5” made by Adobe is used to analyze the images and calculate the area ratios of the martensite and the number of grains of martensite in each field. Next, the area ratios of martensite and the number of grains of martensite in the 10 fields are totaled up and the total area ratio of martensite is divided by the total number of grains of martensite to calculate the mean area ratio per martensite grain. The circle equivalent diameter is calculated from the mean area ratio and number of grains and the obtained circle equivalent diameter is determined as the mean grain size of the martensite. The observed area is made 150 μm in the sheet thickness direction and 250 μm in a direction vertical to the sheet thickness direction (the observed area in this case being 150×250-37500 μm²).

### [Mean Aspect Ratio of Martensite: 2.5 or More]

According to another preferred embodiment of the present invention, the mean aspect ratio of martensite in the microstructure is 2.5 or more. By controlling the mean aspect ratio of martensite to 2.5 or more, it becomes possible to obtain a state where a larger strain is imparted and becomes possible to improve the strength of the steel sheet. The mean aspect ratio of the martensite may be 2.6 or more, 2.8 or more, or 3.0 or more. The upper limit is not particularly prescribed, but, for example, the mean aspect ratio of the martensite may also be 6.0 or less, 5.0 or less, 4.0 or less, 3.8 or less, or 3.6 or less.

The mean aspect ratio of martensite is determined in the following way. First, in a steel sheet etched by LePera's reagent, 10 fields are examined by a power of 500× or 1000× in a region of sheet thickness ½ position from the surface in the sheet thickness direction. Image analysis software of “Photoshop® CS5” made by Adobe is used to analyze the images and calculate the aspect ratios of the ratios of the long axes and short axes for the martensite grains. Next, the aspect ratios of all of the martensite grains in the 10 fields are arithmetically averaged to determine the mean aspect ratio of martensite. The observed area is made 150 μm in the sheet thickness direction and 250 μm in a direction vertical to the sheet thickness direction (the observed area in this case being 150×250=37500 μm²).

### [Preferred Chemical Composition of Steel Sheet]

The present invention, as explained above, has as its object the provision of a panel excellent in appearance after forming even if high in strength and achieves the object by including martensite in the microstructure of the steel sheet forming the panel and by controlling the surface properties of the panel after forming using the two different parameters of the surface texture aspect ratio Str and the surface roughness parameter Sa so that the Str becomes 0.50 to 1.00 and the Sa becomes 0.50 μm or less in range. Therefore, it is clear that the chemical composition itself of the steel sheet is not an essential technical feature in achieving the object of the present invention. Below, a preferred chemical composition of the steel sheet according to an embodiment of the present invention will be explained in detail, but the explanation is intended as merely an illustration of the preferred chemical composition of a steel sheet having, for example, a tensile strength of 400 to 900 MPa and is not intended to limit the present invention to a steel sheet having such a specific chemical composition. Further, in the following explanation, the units “%” of contents of the elements mean “mass %” unless otherwise indicated. Furthermore, in this Description, the “to” showing a numerical range, unless otherwise indicated, is used in a sense including the numerical values shown before and after it as a lower limit value and upper limit value.

In an embodiment of the present invention, for example, the steel sheet preferably has a chemical composition comprising, by mass %,
C: 0.030 to 0.100%,
Si: 0.005 to 1.500%,
Mn: 0.70 to 3.00%,
P: 0.1000% or less,
S: 0.0200% or less,
Al: 1.000% or less,
N: 0.0200% or less,
O: 0.0100% or less,
Nb: 0 to 0.400%,
Cr: 0 to 1.00%,
Mo: 0 to 0.80%,
B: 0 to 0.0100%,
Ti: 0 to 0.200%,
V: 0 to 0.500%,
Ni: 0 to 1.00%,
Cu: 0 to 1.00%,
W: 0 to 1.00%,
Ta: 0 to 0.10%,
Co: 0 to 3.00%,
Sn: 0 to 1.00%,
Sb: 0 to 0.200%,
Ca: 0 to 0.0100%,
Mg: 0 to 0.0100%,
Zr: 0 to 0.0100%,
REM: 0 to 0.0100%,
Bi: 0 to 0.0500%,
As: 0 to 0.10%, and
balance: Fe and impurities.

Below, the elements will be explained in more detail.

### [C: 0.030 to 0.100%]

C is an element securing a predetermined amount of martensite and improving the strength of a steel sheet. To sufficiently obtain such an effect, the C content is 0.030% or more. The C content may also be 0.040% or more or 0.050% or more. On the other hand, if excessively containing C, the strength becomes too high and sometimes the elongation falls. For this reason, the C content is 0.100% or less. The C content may also be 0.090% or less, 0.080% or less, 0.079% or less, 0.078% or less, 0.076% or less, 0.074% or less, 0.072% or less, 0.070% or less, or 0.060% or less.

### [Si: 0.005 to 1.500%]

Si is an element improving the strength of a steel sheet by solution strengthening. To sufficiently obtain such an effect, the Si content is 0.005% or more. The Si content may also be 0.010% or more, 0.100% or more, 0.200% or more, 0.300% or more, or 0.400% or more. On the other hand, if excessively containing Si, removal of the scale formed in the hot rolling becomes difficult and sometimes deterioration of the appearance is invited. Therefore, the Si content is 1.500% or less. The Si content may also be 1.200% or less, 1.000% or less, 0.800% or less, 0.700% or less, or 0.600% or less.

### [Mn: 0.70 to 3.00%]

Mn is an element raising the hardenability and contributing to improvement of the steel sheet strength. To sufficiently obtain such an effect, the Mn content is 0.70% or more. The Mn content may also be 0.80% or more, 1.00% or more, 1.20% or more, or 1.50% or more. In a preferable method of production of the steel sheet explained later, to make the martensite in the finally obtained microstructure be uniformly dispersed in both of the microregions and macroregions, it is necessary to form the microstructure in the steel sheet before the final annealing by structures mainly comprised of bainite and/or martensite. For this reason, improvement of the hardenability by addition of Mn can be said to be important in improving the appearance after forming. On the other hand, if excessively containing Mn, ferrite transformation is excessively suppressed, the desired amount of ferrite cannot be secured, and the elongation sometimes falls. For this reason, the Mn content is 3.00% or less. The Mn content may also be 2.80% or less, 2.50% or less, 2.20% or less, or 2.00% or less.

### [P: 0.1000% or Less]

P is an impurity element and an element causing embrittlement of the welded part and deterioration of the plateability. For this reason, the P content is 0.1000% or less. The P content may also be 0.0600% or less, 0.0400% or less, 0.0200% or less, or 0.0100% or less. The smaller the P content, the more preferable. The lower limit is not particularly prescribed, but may also be 0%. On the other hand, in practical steel sheet, if reducing the P content to less than 0.0001%, the production costs excessively rise and become economically disadvantageous. For this reason, the P content may also be 0.0001% or more, 0.0002% or more, or 0.0005% or more.

### [S: 0.0200% or Less]

S is an impurity element and an element which obstructs weldability and further obstructs manufacturability at the time of casting and the time of hot rolling. For this reason, the S content is 0.0200% or less. The S content may also be 0.0150% or less, 0.0120% or less, 0.0100% or less, 0.0060% or less, or 0.0030% or less. The smaller the S content, the more preferable. The lower limit is not particularly prescribed and may also be 0%. On the other hand, in practical steel sheet, if reducing the S content to less than 0.0001%, the production costs excessively rise and become economically disadvantageous. For this reason, the S content may also be 0.0001% or more, 0.0002% or more, or 0.0005% or more.

### [Al: 1.000% or Less]

Al is an element functioning as a deoxidizer and an element effective for raising the strength of steel. The Al content may also be 0%, but to sufficiently obtain these effects, the Al content is preferably 0.001% or more. The Al content may also be 0.005% or more, 0.010% or more, 0.025% or more, or 0.050% or more. On the other hand, if excessively containing Al, coarse oxides are formed and the toughness is sometimes made to fall. Therefore, the Al content is 1.000% or less. The Al content may also be 0.800% or less, 0.600% or less, or 0.300% or less.

### [N: 0.0200% or Less]

N is an element becoming a cause of formation of blow holes at the time of welding For this reason, the N content is 0.0200% or less. The N content may also be 0.0180% or less, 0.0150% or less, 0.0100% or less, 0.0080% or less, or 0.0060% or less. The smaller the N content, the more preferable. The lower limit is not particularly prescribed and may also be 0%. On the other hand, in practical steel sheet, if reducing the N content to less than 0.0001%, the production costs excessively rise and become economically disadvantageous. For this reason, the N content may also be 0.0001% or more, 0.0002% or more, or 0.0005% or more.

### [O: 0.0100% or Less]

O is an element becoming a cause of formation of blow holes at the time of welding. For this reason, the O content is 0.0100% or less. The 0 content may also be 0.0080% or less, 0.0050% or less, 0.0030% or less, 0.0020% or less. The smaller the O content, the more preferable. The lower limit is not particularly prescribed and may also be 0%. On the other hand, in a practical steel sheet, if reducing the O content to less than 0.0001%, the production costs excessively rise and become economically disadvantageous. For this reason, the O content may also be 0.0001% or more, 0.0002% or more, or 0.0005% or more.

The basic chemical composition of the steel sheet according to an embodiment of the present invention is as explained above. Further, the steel sheet may according with need contain at least one of the following optional elements in place of part of the Fe of the balance for the purpose of improving the properties. For example, the steel sheet may also contain at least one of Nb: 0 to 0.400%, Cr: 0 to 1.00%, Mo: 0 to 0.80%, B: 0 to 0.0100%, Ti: 0 to 0.200%, V: 0 to 0.500%, Ni: 0 to 1.00%, Cu: 0 to 1.00%, W: 0 to 1.00%, Ta: 0 to 0.10%, Co: 0 to 3.00%, Sn: 0 to 1.00%, Sb: 0 to 0.200%, Ca: 0 to 0.0100%, Mg: 0 to 0.0100%, Zr: 0 to 0.0100%, REM: 0 to 0.0100%, Bi: 0 to 0.0500%, and As: 0 to 0.10%. Below, these optional elements will be explained in detail.

### [Nb: 0 to 0.400%]

Nb is an element effective for controlling the form of carbides and an element effective for refinement of the structure and improvement of the toughness of the steel sheet. These effects can be obtained even with a trace amount. The Nb content may also be 0%, but to obtain the above effects, the Nb content is preferably 0.001% or more. The Nb content may also be 0.005% or more or 0.010% or more. On the other hand, if excessively containing Nb, coarse carbides, etc., are formed in the steel and sometimes the toughness of the steel sheet is lowered. For this reason, the Nb content is preferably 0.400% or less. The Nb content may also be 0.200% or less, 0.100% or less, or 0.060% or less.

### [Cr: 0 to 1.00%]

Cr, like Mn, is an element raising the hardenability and contributing to improvement of the steel sheet strength. The Cr content may also be 0%, but to obtain the above effect, the Cr content is preferably 0.001% or more. The Cr content may also be 0.01% or more, 0.10% or more, or 0.20% or more. On the other hand, even if excessively containing Cr, the effect becomes saturated and a rise in the production costs is liable to be invited. Therefore, the Cr content is preferably 1.00% or less and may also be 0.80% or less, 0.60% or less, or 0.40% or less

### [Mo: 0 to 0.80%]

Mo, like Cr, is an element contributing to improvement of the high temperature strength of a steel sheet. This effect can be obtained even by a trace amount. The Mo content may also be 0%, but to obtain the above effect, the Mo content is preferably 0.001% or more. The Mo content may also be 0.01% or more, 0.02% or more, 0.05% or more, or 0.10% or more. On the other hand, if excessively containing Mo, sometimes the hot workability falls and the productivity falls. For this reason, the Mo content is preferably 0.80% or less. The Mo content may also be 0.60% or less, 0.50% or less, 0.40% or less, or 0.20% or less.

### [B: 0 to 0.0100%]

B is an element suppressing the formation of ferrite and pearlite and promoting the formation of martensite in the process of cooling from austenite. Further, B is an element beneficial for raising the strength of steel. These effects can be obtained even by a trace amount.

The B content may also be 0%, but to obtain this effect, the B content is preferably 0.0001% or more. The B content may also be 0.0005% or more or 0.0010% or more. On the other hand, if excessively containing B, sometimes the toughness and/or weldability falls. For this reason, the B content is preferably 0.0100% or less. The B content may also be 0.0080% or less, 0.0050% or less, 0.0030% or less, or 0.0020% or less.

### [Ti: 0 to 0.200%]

Ti is an element effective for controlling the form of carbides. An increase in strength of ferrite can be promoted by Ti. The Ti content may also be 0%, but to obtain these effects, the Ti content is preferably 0.001% or more. The Ti content may also be 0.002% or more, 0.010% or more, 0.020% or more, or 0.040% or more. On the other hand, even if excessively containing Ti, the effect becomes saturated and a rise in the production costs is liable to be invited. Therefore, the Ti content is preferably 0.200% or less and may also be 0.100% or less, 0.080% or less, or 0.050% or less.

### [V: 0 to 0.500%]

V, like Ti, is an element effective for control of the form of carbides and an element effective also for refinement of the structure and improvement of the toughness of a steel sheet. The V content may also be 0%, but to obtain the above effect, the V content is preferably 0.001% or more. The V content may also be 0.005% or more, 0.010% or more, or 0.050% or more. On the other hand, if excessively including V, sometimes a large amount of precipitates is formed and the toughness is lowered. For this reason, the V content is preferably 0.500% or less. The V content may also be 0.400% or less, 0.200% or less, or 0.100% or less.

### [Ni: 0 to 1.00%]

### [Cu: 0 to 1.00%]

### [W: 0 to 1.00%]

Ni, Cu, and W are elements effective for improvement of the strength of a steel sheet. The Ni, Cu, and W contents may also be 0%, but to obtain such an effect, the Ni, Cu, and W contents are preferably respectively 0.001% or more and may also be 0.01% or more or 0.05% or more. On the other hand, if excessively containing these elements, sometimes the weldability of the steel sheet falls. For this reason, the Ni, Cu, and W contents are preferably 1.00% or less and may also be 0.80% or less, 0.40% or less, or 0.20% or less.

### [Ta: 0 to 0.10%]

Ta, like W, is an element effective for control of the form of carbides and improvement of the steel sheet strength. The Ta content may also be 0%, but to obtain these effects, the Ta content is preferably 0.001% or more. The Ta content may also be 0.01% or more or 0.03% or more. On the other hand, even if excessively containing Ta, the effect becomes saturated. Inclusion more than necessary in the steel sheet invites a rise in the production costs. For this reason, the Ta content is preferably 0.10% or less. The Ta content may also be 0.08% or less, 0.06% or less, or 0.04% or less.

### [Co: 0 to 3.00%]

Co is an element effective for improvement of the strength of a steel sheet. The Co content may also be 0%, but to obtain such an effect, the Co content is preferably 0.001% or more. The Co content may also be 0.01% or more, 0.05% or more, or 0.10% or more. On the other hand, if excessively including Co, sometimes the hot workability falls. An increase in the costs of the starting materials is also led to. For this reason, the Co content is preferably 3.00% or less. The Co content may also be 2.00% or less, 1.00% or less, 0.50% or less, or 0.20% or less.

### [Sn: 0 to 1.00%]

Sn is an element able to be contained in a steel sheet if using scrap as a starting material of the steel sheet. Further, Sn is liable to invite embrittlement of the ferrite. For this reason, the smaller the Sn content, the more preferable. It may also be 1.00% or less. The Sn content may also be 0.10% or less, 0.040% or less, or 0.02% or less. The Sn content may also be 0%, but reducing the Sn content to less than 0.001% invites an excessive increase in the refining costs. For this reason, the Sn content may also be 0.001% or more, 0.005% or more, or 0.01% or more.

### [Sb: 0 to 0.200%]

Sb, like Sn, is an element able to be contained in a steel sheet if using scrap as a starting material of the steel sheet. Further, Sb strongly segregates at the grain boundaries and is liable to invite embrittlement of the grain boundaries. For this reason, the smaller the Sb content, the more preferable. It may also be 0.200% or less. Sb content is 0.100% or less, 0.040% or less, or 0.020% or less. The Sb content may also be 0%, but reducing the Sb content to less than 0.001% invites an excessive increase in the refining costs. For this reason, the Sb content may also be 0.001% or more, 0.005% or more, or 0.010% or more.

### [Ca: 0 to 0.0100%]

### [Mg: 0 to 0.0100%]

### [Zr: 0 to 0.0100%]

### [REM: 0 to 0.0100%]

Ca, Mg, Zr, and REM are elements contributing to improvement of the formability of steel sheet. The Ca, Mg, Zr, and REM contents may also be 0%, but to obtain such an effect, the Ca, Mg, Zr, and REM contents are preferably respectively 0.0001% or more and may also be 0.0005% or more, 0.0010% or more, or 0.0015% or more. On the other hand, if excessively containing these elements, sometimes the ductility of the steel sheet falls. Therefore, the Ca, Mg, Zr, and REM contents are preferably respectively 0.0100% or less and may also be 0.0080% or less, 0.0060% or less, 0.0040% or less, or 0.0020% or less. In this Description, REM″ is the general name of the 17 elements of atomic number 21 scandium (Sc), atomic number 39 yttrium (Y), and the lanthanoid atomic number 57 lanthanum (La) to atomic number 71 lutetium (Lu). The REM content is the total content of these elements.

### [Bi: 0 to 0.0500%]

Bi is an element having the action of raising the formability by refining the solidified structure. The Bi content may also be 0%, but to obtain such an effect, the Bi content is preferably 0.0001% or more and may also be 0.0005% or more, 0.0010% or more, or 0.0030% or more. On the other hand, even if excessively including Bi, the effect becomes saturated. Inclusion more than necessary in the steel sheet invites a rise in the production costs. Therefore, the Bi content is preferably 0.0500% or less and may also be 0.0400% or less, 0.0200% or less, 0.0100% or less, or 0.0050% or less.

### [As: 0 to 0.10%]

As, like Sn and Sb, is an element contained in a steel sheet when using scrap as a starting material of the steel sheet. Further, As is an element strongly segregating at the grain boundaries. The smaller the As content, the more preferable. The As content is preferably 0.10% or less and may also be 0.04% or less or 0.02% or less. The As content may also be 0%, but reducing the As content to less than 0.001% invites an excessive increase in refining costs. For this reason, the As content may be 0.001% or more, 0.005% or more, or 0.01% or more.

In the steel sheet according to an embodiment of the present invention, the balance aside from the above elements is comprised of Fe and impurities. The “impurities” are elements entering from the steel starting materials and/or steelmaking process and allowed to be present in a range not detracting from the properties of the steel sheet according to an embodiment of the present invention.

The chemical composition of the steel sheet according to an embodiment of the present invention may be measured by a general analysis method. For example, the chemical composition of the steel sheet may be measured using inductively coupled plasma-atomic emission spectrometry (ICP-AES) based on a test piece taken from a flat part at the center side part of the panel. C and S can be measured using the combustion-infrared absorption method, N using the inert gas melting-thermal conductivity method, and O using the inert gas melting-nondispersive type infrared absorption method.

### [Plating]

The steel sheet according to an embodiment of the present invention may be a cold rolled steel sheet, but may further contain a plating layer at the surface for the purpose of improving the corrosion resistance, etc. The plating layer may also be either of a hot dip coating layer and electroplating layer. That is, the steel sheet according to an embodiment of the present invention may also be a cold rolled steel sheet having a hot dip coating layer or electroplating layer at its surface. The hot dip coating layer, for example, includes a hot dip galvanizing layer (GI), hot dip galvannealing layer (GA), hot dip aluminum coating layer, hot dip Zn—Al alloyed plating layer, hot dip Zn—Al—Mg alloy coating layer, hot dip Zn—Al—Mg—Si alloy coating layer, etc. The electroplating layer, for example, includes an electrogalvanizing layer (EG), electro Zn—Ni alloy plating layer, etc. Preferably, the plating layer is a hot dip galvanizing layer, hot dip galvannealing layer, or electrogalvanizing layer. The amount of deposition of the plating layer is not particularly limited and may be a general amount of deposition.

### [Thickness of Steel Sheet or Panel]

The flat part of the center side part of the steel sheet and the corresponding panel is not particularly limited, but, for example, has a 0.2 to 2.0 mm sheet thickness. The sheet thickness may also be 0.3 mm or more or 0.4 mm or more. Similarly, the sheet thickness may also be 1.8 mm or less, 1.5 mm or less, 1.2 mm or less, 1.0 mm or less, or 0.8 mm or less. For example, by making the sheet thickness 0.2 mm or more, maintaining the shape of the part flat becomes easy and the additional effect of improvement of the dimensional precision and shape precision can be obtained. On the other hand, by making the sheet thickness 0.8 mm or less, the effect of lightening the weight of the part becomes remarkable. The sheet thickness of the steel sheet or panel is measured by a micrometer.

### [Mechanical Properties]

### [Tensile Strength: TS]

According to the panel having the above features, a high tensile strength, specifically a tensile strength of 400 MPa or more can be achieved. The tensile strength is preferably 440 MPa or more or 490 MPa or more, more preferably 540 MPa or more or 590 MPa or more. The upper limit is not particularly prescribed, but, for example, the tensile strength may also be 900 MPa or less, 860 MPa or less, or 800 MPa or less. The tensile strength is measured by taking a No. 5 tensile test piece of JIS Z2241:2022 from the steel sheet at the flat part of the center side part of the panel and running a tensile test based on JIS Z2241:2022.

### [Yield Stress: YS]

According to the panel having the above features, it is possible to achieve a high yield stress, more specifically, if performing paint baking, a 300 MPa or more yield stress. The yield stress after paint baking is preferably 350 MPa or more or 400 MPa or more, more preferably 490 MPa or more or 540 MPa or more. The upper limit is not particularly prescribed, but, for example, the yield stress after paint baking may be 850 MPa or less, 800 MPa or less, or 750 MPa or less. The yield stress is measured by taking a No. 5 tensile test piece of JIS Z2241:2022 from a steel sheet at the flat part of the center side part of the panel and running a tensile test based on JIS Z2241:2022. Specifically, the 0.2% yield strength measured at the tensile test is determined as the yield stress.

The panel according to an embodiment of the present invention can achieve high strength, more specifically a tensile strength of 400 MPa or more. Despite this, it is possible to maintain excellent appearance after press-forming or other forming. For this reason, the panel according to an embodiment of the present invention, for example, is extremely useful for use in automobiles in roofs, hoods, fenders, doors, and other outer parts where high design sense is sought.

### <Method of Production of Steel Sheet and Panel>

Next, a preferable method of production of a steel sheet and panel according to an embodiment of the present invention will be explained. The following explanation is intended to illustrate a characteristic method for production of the steel sheet and panel according to an embodiment of the present invention and is not intended to limit the steel sheet and panel to ones produced by the method of production explained below.

### <Method of Production of Steel Sheet>

The method of production of the steel sheet according to an embodiment of the present invention comprises
hot rolling including heating a slab having a chemical composition explained above in relation to a steel sheet to a temperature of 1100 to 1400° C. and finish rolling it, then coiling it at a temperature of 500 to 700° C., wherein an end temperature of the finish rolling is 800 to 1350° C.,
pickling the obtained hot rolled steel sheet,
cold rolling the pickled hot rolled steel sheet by a rolling reduction of 20 to 90%,
primary annealing the obtained cold rolled steel sheet, wherein the primary annealing includes heating the cold rolled steel sheet and holding it at a highest heating temperature of Ac3 to 950° C. for 10 to 500 seconds, then controlling the mean cooling speed in a temperature region of 500 to 700° C. to 40° C./s or more and cooling down to a cooling stop temperature of 350° C. or less, and
secondary annealing the cold rolled steel sheet after primary annealing, wherein the secondary annealing includes heating the cold rolled steel sheet and holding it at a highest heating temperature of (Ac1+20) to 820° C. for 10 to 500 seconds, then controlling the mean cooling speed in a temperature region of 500 to 700° C. to 10° C./s or more and, furthermore, controlling the mean cooling speed in a temperature region of 200 to 500° C. to 40° C./s or more. Below, the steps will be explained in more detail.

### [Hot Rolling Step]

### [Heating of Slab]

First, a slab having the chemical composition explained above in relation to the steel sheet is heated. The slab used is preferably cast by the continuous casting method from the viewpoint of productivity, but it may also be produced by the ingot making method or the thin slab casting method. The slab used contains a relatively large amount of alloy elements for obtaining a high strength steel sheet. For this reason, it is necessary to heat the slab before being supplied for hot rolling to dissolve the alloy elements in the slab. If the heating temperature is less than 1100° C., the alloy elements will not sufficiently dissolve in the slab but remain as coarse alloy carbides and sometimes will case brittle fracture during hot rolling. For this reason, the heating temperature is preferably 1100° C. or more. The upper limit of the heating temperature is not particularly prescribed, but is preferably 1400° C. or less from the viewpoint of the capacity of the heating facilities and productivity.

### [Rough Rolling]

In the present method, for example, the heated slab may be rough rolled before the finish rolling so as to adjust the sheet thickness, etc. The rough rolling need only secure the desired sheet bar dimensions. The conditions are not particularly limited.

### [Finish Rolling and Coiling]

The heated slab or the slab additionally rough rolled according to need is next finish rolled. The slab used in the above way contains a relatively large amount of alloy elements, therefore it is necessary to enlarge the rolling load at the time of hot rolling. For this reason, hot rolling is preferably performed at a high temperature. In particular, the end temperature of the finish rolling is important on the point of control of the microstructure of the steel sheet. If the end temperature of the finish rolling is low, the microstructure becomes uneven and sometimes the formability falls. For this reason, the end temperature of the finish rolling is 800° C. or more. On the other hand, to suppress coarsening of austenite, the end temperature of the finish rolling is 1350° C. or less. The end temperature of the finish rolling is preferably 950 to 1050° C. Next, the finish rolled hot rolled steel sheet is coiled up at a 500 to 700° C. coiling temperature. By making the coiling temperature 500 to 700° C., it is possible to suppress the growth of oxide scale. The coiling temperature is preferably 550 to 630° C.

### [Pickling Step]

Next, the obtained hot rolled steel sheet is pickled to remove the oxide scale formed on the surface of the hot rolled steel sheet. The pickling may be performed under suitable conditions for removing the oxide scale. It may be performed once or divided into several times for reliably removing the oxide scale.

### [Cold Rolling Step]

The pickled hot rolled steel sheet is cold rolled in the cold rolling step by a rolling reduction of 20 to 90%. By making the rolling reduction of the cold rolling 20% or more, the cold rolled steel sheet is kept flat in shape and a drop in ductility in the final product can be suppressed. On the other hand, by making the rolling reduction of the cold rolling 90% or less, it is possible to prevent the rolling load from becoming excessive and the rolling from becoming difficult. The rolling reduction of the cold rolling is preferably 70 to 90%. The number of rolling passes and the rolling reduction of each of the passes are not particularly limited. They may be suitably set so that the rolling reduction of the cold rolling as a whole becomes the above range.

### [Primary Annealing Step]

The obtained cold rolled steel sheet is heated at the next primary annealing step, held at the highest heating temperature of Ac3 to 950° C. for 10 to 500 seconds, then controlled in the temperature region of 500 to 700° C. by a mean cooling speed of 40° C./s or more and cooled down to a cooling stop temperature of 350° C. or less. Here, the Ac3 point (C) is found by cutting out a small piece from the cold rolled steel sheet and measuring the heat expansion of the small piece during heating from room temperature by 10° C./s to 1000° C. By holding at a temperature of the Ac3 point or more for a sufficient time, it becomes possible to promote austenization and by cooling by subsequent rapid cooling down to a 350° C. or less temperature, it becomes possible to form the microstructure in the steel sheet after cooling reliably by structures mainly comprised of bainite and/or martensite, i.e., for example, by full bainite or full martensite. Here, the “structures mainly comprised of bainite and/or martensite” means structures containing at least one of bainite and martensite in a total area ratio of 90% or more, “full bainite” means structures comprised of an area ratio of 100% of bainite, and “full martensite” means structures comprised of an area ratio of 100% of martensite. A bainite and/or martensite structure is a structure having many various interfaces inside it compared with ferrite or other structures. For this reason, by forming the microstructure at the steel sheet before the secondary annealing step, i.e., the final annealing step, by bainite and/or martensite, it becomes possible to form an extremely large number of carbides able to serve as sites for forming nuclei of austenite on these interfaces at the stage of heating the microstructure in the secondary annealing. As a result, austenite is formed finely and uniformly in the steel sheet as a whole from such many dispersed nuclei forming sites then martensite is formed from these austenite whereby the mean grain interval of martensite in the microstructure obtained after the secondary annealing is controlled to 2.5 μm or less and the standard deviation in the area ratio of martensite of the direction vertical to the rolling direction and sheet thickness direction is controlled to 1.5% or less. That is, it becomes possible to achieve a microstructure with martensite uniformly dispersed in both of the microregions and macroregions.

If the highest heating temperature at the primary annealing step is less than the Ac3 point or the holding time is less than 10 seconds, the austenization becomes insufficient and the microstructure in the steel sheet cannot be formed by structures mainly comprised of bainite and/or martensite even by subsequent cooling. That is, the total of the area ratios of bainite and martensite cannot be made 90% or more. On the other hand, higher temperature and longer time heating and holding cause the productivity to fall, therefore the highest heating temperature at the primary annealing step is made 950° C. or less and the holding time is made 500 seconds or less. The highest heating temperature is preferably 870 to 950° C. while the holding time is preferably 50 to 100 seconds.

Further, if the mean cooling speed in the temperature region of 500 to 700° C. at the primary annealing step is less than 40° C./s or the cooling stop temperature is more than 350° C., during cooling, ferrite is produced and the microstructure in the steel sheet cannot be made a total of the area ratios of bainite and martensite of 90% or more. Therefore, the mean cooling speed has to be 40° C./s or more, preferably 70° C./s. The upper limit is preferably 300° C./s or less, more preferably 150° C./s or less. On the other hand, the lower limit of the cooling stop temperature is not particularly prescribed. For example, the cooling stop temperature may also be room temperature (25° C.) or more, preferably is 200° C. or more. Similarly, the cooling stop temperature is preferably 300° C. or less.

### [Secondary Annealing Step (Final Annealing Step)]

The cold rolled steel sheet after primary annealing is heated again in the next secondary annealing step, is held at the highest heating temperature of (Ac1+20) to 820° C. for 10 to 500 seconds, then is cooled by controlling the mean cooling speed in the temperature region of 500 to 700° C. to 10° C./s or more and further controlling the mean cooling speed in the temperature region of 200 to 500° C. to 40° C./s or more. Here, the Ac1 point (° C.), like the case of the Ac3 point, is found by cutting out a small piece from the cold rolled steel sheet and examining the heat expansion of the small piece during heating from room temperature by 10° C./s to 1000° C. First, at the stage of heating the steel sheet after primary cooling up to the highest heating temperature of (Ac1+20) to 820° C., it is possible to form carbides dispersed on the many interfaces included in the bainite and/or martensite in the microstructure. Next, by holding at the highest temperature region corresponding to the dual phase region of ferrite and austenite for 10 to 500 seconds, it is possible to maintain a state in which carbides are dispersed on the interfaces while forming austenite finely and uniformly in the steel sheet as a whole from the carbides. Finally, by controlling the mean cooling speed in the temperature region of 500 to 700° C. to 10° C./s or more and further controlling the mean cooling speed in the temperature region of 200 to 500° C. to 40° C./s or more, it is possible to suitably form martensite from the finely dispersed austenite. As a result, the mean grain interval of the martensite is controlled to 2.5 μm or less and the standard deviation in the area ratio of martensite in the direction vertical to the rolling direction and sheet thickness direction is controlled to 1.5% or less. That is, it becomes possible to achieve a microstructure in which martensite is uniformly dispersed in both of the microregions and macroregions.

If the highest heating temperature in the secondary annealing step is less than Ac1+20° C. or the holding time is less than 10 seconds, it is not possible to obtain the above such desired microstructure. On the other hand, if the highest heating temperature is more than 820° C., the area ratio of austenite becomes too high and the area ratio of ferrite cannot be made 75% or more. Furthermore, due to the high temperature, it becomes no longer possible to maintain a state in which carbides are dispersed on the interfaces and, at the finally obtained microstructure, it becomes no longer possible to achieve uniform dispersion of martensite at both the microregions and macroregions. Further, if the holding time is more than 500 seconds, the austenite grains become coarser and the martensite grains obtained by the subsequent cooling also become relatively coarse. In such a case, it is not possible to obtain a fine martensite structure with a mean grain interval of martensite controlled to 2.5 μm or less. The highest heating temperature is preferably 760 to 800° C. and the holding time is preferably 20 to 100.

Further, if the mean cooling speed in the temperature region of 500 to 700° C. in the secondary annealing step is less than 10° C./s, transformation from austenite to bainite, etc., is promoted. Even if subsequent cooling is suitably performed, sometimes the desired amount of martensite cannot be obtained. In this case, the desired strength can no longer be achieved and/or uniform dispersion of martensite at the microregions can no longer be achieved. Therefore, the mean cooling speed in the temperature region of 500 to 700° C. has to be 10° C./s or more, preferably 40° C./s or more. The upper limit is, for example, 200° C./s or less, preferably 60° C./s or less. On the other hand, if the mean cooling speed in the temperature region of 200 to 500° C. is less than 40° C./s, transformation from austenite to martensite cannot be promoted and similarly a greater amount of bainite and other structures is produced. Therefore, the mean cooling speed in the temperature region of 200 to 500° C. has to be 40° C./s or more, preferably 50° C./s or more. The upper limit is, for example, 200° C./s or less, preferably 80° C./s or less.

The above method produces the steel sheet according to an embodiment of the present invention by two annealing treatments including a first annealing and secondary annealing, The steel sheet according to an embodiment of the present invention is not necessarily limited to one produced by such a method. For example, it can be produced by one annealing treatment. More specifically, by forming the microstructure of the steel sheet after the hot rolling step by full bainite or full martensite, it is possible to omit the primary annealing explained previously. However, in this case, it is necessary to suitably control the cooling conditions after the hot rolling, the coiling temperature, etc. Further, control of the rolling reduction in the subsequent cold rolling also becomes important. That is to say, this is because if the rolling reduction at the cold rolling becomes higher, recrystallization occurs at the time of heating in the subsequent annealing step and it becomes no longer possible to maintain the microstructure formed at the hot rolling step.

### [Plating Step]

To improve the corrosion resistance, etc., the surface of the obtained cold rolled steel sheet may also be plated. The plating treatment may be hot dip coating, alloyed hot dip coating, electroplating, or other treatment. For example, as the plating treatment, the steel sheet may be hot dip galvanized and may be hot dip galvanized, then alloyed. The specific conditions of the plating treatment and alloying treatment are not particularly limited and may be any suitable conditions known to persons skilled in the art. For example, in hot dip coating treatment, the plating bath sheet dipping temperature (temperature of steel sheet when dipped in hot dip galvanization bath) is preferably a temperature range from a temperature 40° C. lower than the hot dip galvanization bath temperature (hot dip galvanization bath temperature-40° C.) to a temperature 50° C. higher than the hot dip galvanization bath temperature (hot dip galvanization bath temperature+50° C.). If alloying the hot dip galvanization layer, the steel sheet formed with the hot dip galvanization layer is preferably heated to a temperature range of 460 to 600° C., more preferably is heated to a temperature range of 480 to 550° C.

### <Method of Production of Panel>

The method of production of a panel according to the present invention comprises
blanking the steel sheet obtained above,
forming the blanked steel sheet into a steel part, and
optionally, painting the formed steel part. Below, each step will be explained in more detail.

### [Blanking Step]

In the blanking step, the steel sheet obtained above is cut to a predetermined size by blanking. The blanking can, for example, be performed by stamping by a press or any other suitable means known to a person skilled in the art.

### [Forming Step]

The blanked steel sheet (blank) is formed into a steel part in the following forming step. For example, if bending the blank in a direction perpendicular to its rolling direction to introduce strain in a direction perpendicular to rolling, sometimes it is not possible to suitably control the Str and/or Sa in the formed panel to within a predetermined range. In such a case, ghost lines and other defects in appearance remarkably occur. Therefore, in the forming step, the forming is preferably performed so that the rolling direction of the blank and the direction of bending where the largest curvature is formed match. By performing such bending, even in the case of high strength steel sheet containing martensite, it is possible to sufficiently reduce the introduction of strain in a direction perpendicular to rolling, therefore it becomes possible to suppress or reduce the occurrence of ghost lines or other defects in appearance.

Further, it is necessary to suitably control the amount of strain imparted in the forming step. If the amount of strain is small, while this does not necessarily affect the appearance after forming disadvantageously, sometimes insufficient dislocations are introduced. In this case, the amount of bake hardening at the time of baking on the paint falls and it becomes no longer possible to sufficiently raise the yield stress. As a result, the dent resistance of the final product falls. Therefore, from the viewpoint of improvement of the dent resistance, the amount of strain imparted in the forming step is preferably 2.0% or more at the flat part of the center side part of the panel. On the other hand, imparting excessive strain makes the surface roughness parameter Sa of the flat part and/or end part of the final product increase and as a result invites a drop in appearance after forming. Therefore, from the viewpoint of improvement of the appearance after forming, the amount of strain imparted in the forming step is preferably 5.0% or less at the flat part of the center side part of the panel.

### [Painting Step]

The steel part formed is optionally painted in the next painting step. Preferably paint baking is performed. This painting, for example, includes the three types of painting of electrodeposition painting, intermediate coat painting, and topcoat painting (base and clear paint). For the painting, a water-based paint or solvent paint is used. In electrodeposition painting, the steel part is immersed in an electrodeposition tank filled with paint. In that state, the entire surface of the steel part is painted by electrodeposition. Further, in intermediate coat painting, paint is sprayed from a spray nozzle to a steel part by a painting robot or by manual work by a worker so that the surface of the steel part as a whole is covered by an intermediate coat. Further, in the topcoat painting, paint is sprayed from a spray nozzle to a steel part by a painting robot or by manual work by a worker so that the surface of the steel part as a whole is covered by a topcoat. Due to this, the surface of the steel part is covered by a paint layer of a thickness of 60 to 200 μm.

### [Paint Baking]

Paint baking is bake drying treatment for baking a paint layer on a steel part and treatment for bake hardening the steel part. The paint baking may be performed in the painting step after the electrodeposition painting and before the intermediate coating painting, may be performed between one intermediate coating painting and another intermediate coating painting performed several times, may be performed after the intermediate coating painting and before the topcoat painting, may be performed between one topcoat painting and another topcoat painting performed several times, and may be performed after the topcoat painting.

The temperature and time of the paint baking are preferably controlled so that the drying parameter P expressed by the following formula 1 becomes in the range of 7500 to 10000. The specific temperature and time of the paint baking may be suitably selected within a range satisfying the following formula 1 from, for example, the ranges of 100 to 220° C. and 20 to 60 minutes.

$$P = ( T + 273 ) \times ( 17.7 + log ( t ) ) \qquad formula 1$$

wherein, T is the temperature of the paint baking (° C.) and “t” is the time of the paint baking (s).

If the paint baking is performed several times, the total of the time periods of the paint baking is preferably controlled to become 20 to 60 minutes in range. Similarly, the drying parameter P is preferably controlled so that the cumulative value of the drying parameters calculated from the temperatures and times of the individual paint bakings becomes 7500 to 10000 in range. If the drying parameter P is less than 7500, the amount of bake hardening falls and as a result sometimes it is not possible to sufficiently raise the yield stress after bake hardening. In this case, the dent resistance of the final product falls. On the other hand, if the drying parameter P becomes more than 10000, due to the excessive baking, the yield stress after bake hardening falls. Similarly, sometimes the dent resistance of the final product falls.

According to the panel produced by the above method of production, by including martensite in the microstructure of the steel sheet forming the panel, it is possible to achieve higher strength while by controlling the surface properties of the panel to within the range of a Str of 0.50 to 1.00 and an Sa of 0.50 μm or less, it is possible to remarkably suppress the occurrence of ghost lines and other defects in appearance at the panel surface even in a case where strain is imparted by press-forming or other forming. Furthermore, if baking the paint of the panel, it is possible to remarkably raise the yield stress by bake hardening, therefore it is possible to improve the dent resistance of the panel. Therefore, the panel produced by the above method of production is particularly useful in use in the field of automobiles where along with higher strength, excellent appearance after forming and further excellent dent resistance are sought.

Below, examples will be used to explain the present invention in more detail, but the present invention is not limited to these examples in any way.

### EXAMPLES

In the following examples, panels according to an embodiment of the present invention are manufactured under various conditions and the properties of the obtained panels are investigated.

### [Production of Steel Sheet]

First, molten steels were cast by continuous casting to form slabs having the various chemical compositions shown in Table 1. These slabs were heated to a predetermined temperature of 1100 to 1400° C. and hot rolled. The hot rolling is performed by rough rolling and finish rolling. The end temperature and coiling temperature of the finish rolling were as shown in Table 2. Next, the obtained hot rolled steel sheets were pickled, then were cold rolled by the rolling reduction shown in Table 2 to obtain cold rolled steel sheets having 0.4 mm thicknesses. Next, the obtained cold rolled steel sheets were subjected to primary annealing and secondary annealing under the conditions shown in Table 2. Finally, as plating treatment, hot dip galvanization was suitably performed and several sheets among them were alloyed at the alloying temperatures shown in Table 2.

### [Production of Panel]

Next, the obtained cold rolled steel sheet or plated steel sheet is blanked to cut it to a predetermined size blank, then the blank is press-formed under the conditions shown in Table 2 to obtain a steel part of a panel shape. Here, the “OK” of the bending direction in Table 2 means the rolling direction of the blank and the direction of bending at which the largest curvature is formed match. The obtained steel part is washed and dipped for 3 minutes in a 40° C. aqueous solution containing 3 mass % of an aqueous alkaline degreasing agent (FC-301 made by Nihon Parkerizing Co., Ltd.) to degrease it, then was rinsed and dried. Next, the steel part was pretreated by 3 g/m² zinc phosphate treatment (Palbond 3020 (product name) made by Nihon Parkerizing Co., Ltd.), then was coated with cationic electrodeposition paint made by Nippon Paint Co., Ltd. by a slope current of a voltage of 160V. After that, an intermediate coat (EP Primer 1405 (A) made by Kansai Paint Co., Ltd.) and a topcoat (Majicron 1000 made by Kansai Paint Co., Ltd.)) was spray coated. After the electrodeposition painting, after the intermediate coat, and after the top coat, the temperature and time of the paint baking were suitably selected from 100 to 220° C. and 20 to 60 minutes so that the coatings dried and paint baking was performed by the drying parameters P shown in Table 2 to obtain panels provided with paint layers of the thicknesses shown in Table 2. The drying parameters P shown in Table 2 are the cumulative values of the drying parameters calculated from the temperatures and times of the paint bakings of the electrodeposition painting, intermediate coat, and top coat.

TABLE 1

| | Chemical composition (mass %), balance: Fe and impurities | | | | | | | | | | | | | | Ac1 | Ac3 |
|---|---|---|---|---|---|---|---|---|---|---|---|---|---|---|---|---|
| Steel | C | Si | Mn | P | S | Al | N | O | Nb | Cr | Mo | B | Ti | Others | (° C.) | (° C.) |
| A | 0.046 | 0.098 | 2.02 | 0.0140 | 0.0018 | 0.031 | 0.0024 | 0.0009 | 0.018 | 0.21 | | 0.0016 | 0.019 | | 708 | 871 |
| B | 0.081 | 0.086 | 1.91 | 0.0670 | 0.0013 | 0.105 | 0.0040 | 0.0019 | 0.007 | | | 0.0025 | | Ta: 0.05, | 705 | 856 |
| | | | | | | | | | | | | | | Sn: 0.04 | | |
| C | 0.040 | 0.400 | 1.42 | 0.0068 | 0.0008 | 0.110 | 0.0009 | 0.0020 | | | 0.10 | 0.0015 | | Ta: 0.009, | 719 | 890 |
| | | | | | | | | | | | | | | REM: 0.0061 | | |
| D | 0.070 | 0.140 | 2.90 | 0.0546 | 0.0052 | 0.190 | 0.0051 | 0.0020 | | | | | | | 696 | 863 |

TABLE 2

| | | | | | Primary annealing step | | | | Secondary annealing step | | |
|---|---|---|---|---|---|---|---|---|---|---|---|
| | | | | | | | | Mean | | | Mean |
| | | Hot rolling | | Cold | | | | cooling | | | cooling |
| | | step | | rolling | | | | speed in | | | speed in |
| | | Finish | | step | | | Cool- | 500 to | | | 500 to |
| | | rolling | | Rolling | Highest | Hold- | ing | 700° C. | Highest | Hold- | 700° C. |
| | | end | Coiling | reduc- | heating | ing | stop | temp. | heating | ing | temp. |
| Ex. | Steel | temp. | temp. | tion | temp. | time | temp. | region | temp. | time | region |
| no. | no. | (° C.) | (° C.) | (%) | (° C.) | (s) | (° C.) | (° C./s) | (° C.) | (s) | (° C./s) |
| 1 | A | 960 | 608 | 82 | 915 | 98 | 204 | 41 | 768 | 101 | 15 |
| 2 | A | 960 | 600 | 82 | 915 | 100 | 204 | 40 | 757 | 80 | 18 |
| 3 | A | 960 | 609 | 82 | 915 | 99 | 204 | 42 | 768 | 101 | 15 |
| 4 | A | 960 | 607 | 82 | 915 | 100 | 203 | 40 | 768 | 850 | 15 |
| 5 | B | 980 | 597 | 78 | 922 | 103 | 199 | 42 | 773 | 99 | 14 |
| 6 | C | 1090 | 552 | 23 | 920 | 237 | 302 | 238 | 774 | 341 | 54 |
| 7 | C | 1090 | 550 | 23 | 895 | 238 | 300 | 240 | 774 | 341 | 54 |
| 8 | D | 1288 | 503 | 41 | 890 | 170 | 78 | 72 | 737 | 66 | 43 |
| 9 | D | 1287 | 502 | 41 | 840 | 169 | 77 | 71 | 734 | 65 | 42 |

| | Secondary | | | | | | | | |
|---|---|---|---|---|---|---|---|---|---|
| | annealing | | | | | | | | |
| | step | | | | | | | | |
| | Mean | | | | | | | | |
| | cooling | | | | | | | | |
| | speed in | | | | Forming step | | | | |
| | 200 to | Plating step | | | Amount | | Painting step | | |
| | 500° C. | | | Alloy- | of strain | | Coating | Drying | |
| | temp. | | | ing | of flat | | thick- | para- | |
| Ex. | region | | Alloy- | temp. | part | Bending | ness | meter | |
| no. | (° C./s) | Plating | ing | (° C.) | (%) | direction | (μm) | P | Remarks |
| 1 | 81 | Yes | Yes | 550 | 3.5 | OK | 113 | 9205 | Inv. ex. |
| 2 | 81 | Yes | Yes | 550 | 3.9 | OK | 113 | 9205 | Inv. ex. |
| 3 | 81 | Yes | Yes | 550 | 6.8 | OK | 121 | 9205 | Comp. ex. |
| 4 | 81 | Yes | Yes | 550 | 3.1 | OK | 115 | 9205 | Comp. ex. |
| 5 | 121 | Yes | Yes | 520 | 2.7 | OK | 143 | 8029 | Inv. ex. |
| 6 | 162 | Yes | No | — | 4.6 | OK | 76 | 7901 | Inv. ex. |
| 7 | 162 | Yes | No | — | 0.4 | OK | 75 | 7901 | Inv. ex. |
| 8 | 116 | No | No | — | 2.6 | OK | 80 | 9810 | Inv. ex. |
| 9 | 115 | No | No | — | 4.8 | OK | 85 | 9810 | Comp. ex. |

Underlines show outside preferable range.

The properties of the obtained panels were measured and evaluated by the following methods.

### [Evaluation of Appearance]

The appearance after forming into a panel was evaluated by the degree of ghost lines formed at the surface of a door panel after forming. The surface after press-forming was ground down. The stripe patterns with intervals on the order of several mm formed on the surface were judged as ghost lines. These were given a score of 1 to 5 based on the following criteria based on the degree of formation of streak patterns. Any 100 mm×100 mm region was visually checked. A case where no streak patterns were observed at all was evaluated as “1”, a case where a maximum length of the streak patterns was 20 mm or less was evaluated as “2”, a case where a maximum length of the streak patterns was more than 20 mm and 50 mm or less was evaluated as “3”, a case where a maximum length of the streak patterns was more than 50 mm and 70 mm or less was evaluated as “4”, and a case where a maximum length of the streak patterns was more than 70 mm was evaluated as “5”. Cases evaluated as “3” or less were judged as passing as excellent in appearance after forming. On the other hand, cases evaluated as “4” or more were judged as failing as inferior in appearance after forming. The results are shown in Table 3.

TABLE 3

| | | | | | | Martensite | | | | |
|---|---|---|---|---|---|---|---|---|---|---|
| | | Area ratio of | | | Ferrite | | | | Standard | |
| | | microstructure (%) | | | mean | Mean | | Mean | deviation | Sheet |
| | | | | Balance | grain | grain | Mean | grain | of area | thick- |
| Ex. | Steel | | | structure | size | size | aspect | interval | ratio | ness |
| no | no. | Ferrite | Martensite | total | (μm) | (μm) | ratio | (μm) | (%) | (mm) |
| 1 | A | 88 | 12 | 0 | 8.4 | 1.8 | 3.1 | 2.2 | 1.0 | 0.4 |
| 2 | A | 90 | 10 | 0 | 8.8 | 1.8 | 3.0 | 2.1 | 1.0 | 0.4 |
| 3 | A | 89 | 11 | 0 | 8.6 | 1.8 | 3.0 | 2.5 | 1.0 | 0.4 |
| 4 | A | 86 | 14 | 0 | 9.1 | 2.1 | 1.8 | 8.7 | 1.1 | 0.4 |
| 5 | B | 77 | 21 | 2 | 9.6 | 2.1 | 3.5 | 1.4 | 1.3 | 0.4 |
| 6 | C | 81 | 13 | 6 | 15.4 | 4.5 | 3.0 | 2.1 | 0.9 | 0.4 |
| 7 | C | 80 | 10 | 10 | 16.7 | 4.1 | 3.0 | 2.1 | 0.9 | 0.4 |
| 8 | D | 83 | 17 | 0 | 5.6 | 1.1 | 4.1 | 1.7 | 0.9 | 0.4 |
| 9 | D | 64 | 36 | 0 | 5.5 | 1.5 | 3.9 | 1.5 | 1.6 | 0.4 |

| | Flat | End | | Mean | | Evalua- | | |
|---|---|---|---|---|---|---|---|---|
| | part | part | | KAM | | tion of | | |
| Ex. | Sa | Sa | | value/ | YS | appear- | TS | |
| no | (μm) | (μm) | Str | Vm | (MPa) | ance | (MPa) | Remarks |
| 1 | 0.35 | 0.39 | 0.64 | 5.5 | 641 | 1 | 664 | Inv. ex. |
| 2 | 0.34 | 0.38 | 0.62 | 7.9 | 630 | 2 | 650 | Inv. ex. |
| 3 | 0.68 | 0.48 | 0.55 | 8.5 | 656 | 5 | 671 | Comp. ex. |
| 4 | 0.81 | 0.65 | 0.66 | 4.6 | 651 | 5 | 666 | Comp. ex. |
| 5 | 0.41 | 0.39 | 0.71 | 4.7 | 791 | 3 | 822 | Inv. ex. |
| 6 | 0.44 | 0.32 | 0.81 | 6.8 | 380 | 1 | 401 | Inv. ex. |
| 7 | 0.39 | 0.38 | 0.76 | 1.1 | 340 | 3 | 410 | Inv. ex. |
| 8 | 0.41 | 0.33 | 0.69 | 4.1 | 824 | 3 | 856 | Inv. ex. |
| 9 | 0.43 | 0.22 | 0.21 | 7.8 | 820 | 5 | 844 | Comp. ex. |

Underlines indicate outside scope of present invention or outside preferable scope.

Referring to Tables 1 to 3, in Comparative Example 3, the amount of strain imparted in the forming step of the panel was large, therefore the Sa of the steel sheet at the flat part of the panel became more than 0.50 μm and as a result the appearance after forming fell. In Comparative Example 4, the holding time at the secondary annealing step of the production of a steel sheet was long, therefore it is believed the austenite grains became coarser. In relation to this, in the microstructure obtained after the secondary annealing, the mean grain interval of the martensite became more than 2.5 μm and a steel sheet having a microstructure in which martensite was finely and uniformly dispersed as a whole could not be obtained. As a result, the Sa of the steel sheet at the flat part and end part of the panel after forming became more than 0.50 μm and the appearance after forming fell. In Comparative Example 9, the highest heating temperature of the primary annealing step was low, therefore the austenization became insufficient. Even by the subsequent cooling, it is believed it was not possible to form the microstructure in the steel sheet by a structure mainly comprised of bainite and/or martensite. In relation to this, in the microstructure obtained after the secondary annealing, the standard deviation in the area ratio of martensite in the direction vertical to the rolling direction and sheet thickness direction became more than 1.5% and it was not possible to obtain a steel sheet having a microstructure in which martensite was finely and uniformly dispersed in the whole. As a result, the Str of the steel sheet at the flat part of the panel after forming became less than 0.50 and the appearance after forming fell.

In contrast to this, in all of the panels according to the invention examples, by including martensite in the microstructure of the steel sheet forming a panel, it was possible to increase the strength, for example, achieve a tensile strength of 400 MPa or more, while by controlling the surface properties of the panel to an Str of 0.50 to 1.00 and, further, an Sa of 0.50 μm or less in range, even if strain was imparted by press-forming or other forming, it was possible to remarkably suppress the occurrence of defects in appearance such as ghost lines at the panel surface. In particular, in Invention Examples 1, 2, 5, 6, and 8, by using a steel sheet having a microstructure in which martensite is finely and uniformly dispersed overall, i.e., a seel sheet having a microstructure in which a mean grain interval of martensite controlled to 2.5 μm or less and a standard deviation of the area ratio of martensite in a direction vertical to the rolling direction and sheet thickness direction is controlled to 1.5% or less, and forming it to give a mean KAM value/Vm of 1.8 or more, it was possible to achieve a 350 MPa or more YS and therefore possible to remarkably improve the dent resistance. This is believed to be because by imparting suitable strain to a steel sheet in which martensite is uniformly dispersed, more dislocations were uniformly introduced and it was possible to raise the amount of bake hardening.

1-6. (canceled)

7. A panel comprising a steel sheet having a microstructure comprising martensite, wherein
a surface texture aspect ratio Str of the steel sheet at a flat part of a center side part of the panel is 0.50 to 1.00, and
a surface roughness parameter Sa of the steel sheet at the flat part of the center side part and an end part of the panel is 0.50 μm or less.

8. The panel according to claim 7, wherein a ratio of a mean KAM value/Vm of a mean KAM value of ferrite contained in the steel sheet and a volume ratio Vm of the martensite is 1.8 or more.

9. A panel according to claim 7, wherein the steel sheet is a painted steel sheet provided with a paint layer on at least one surface.

10. A panel according to claim 8, wherein the steel sheet is a painted steel sheet provided with a paint layer on at least one surface.

11. The panel according to claim 7, wherein
the microstructure of the steel sheet in the flat part comprises, by area %,
ferrite: 75 to 95%,
martensite: 5 to 25%, and
at least one of bainite, pearlite, and retained austenite: 0 to 10% in total,
a mean grain interval of martensite is 2.5 μm or less, and
a standard deviation in an area ratio of martensite in a direction vertical to a rolling direction and sheet thickness direction is 1.5% or less.

12. The panel according to claim 8, wherein
the microstructure of the steel sheet in the flat part comprises, by area %,
ferrite: 75 to 95%,
martensite: 5 to 25%, and
at least one of bainite, pearlite, and retained austenite: 0 to 10% in total,
a mean grain interval of martensite is 2.5 μm or less, and
a standard deviation in an area ratio of martensite in a direction vertical to a rolling direction and sheet thickness direction is 1.5% or less.

13. The panel according to claim 9, wherein
the microstructure of the steel sheet in the flat part comprises, by area %,
ferrite: 75 to 95%,
martensite: 5 to 25%, and
at least one of bainite, pearlite, and retained austenite: 0 to 10% in total,
a mean grain interval of martensite is 2.5 μm or less, and
a standard deviation in an area ratio of martensite in a direction vertical to a rolling direction and sheet thickness direction is 1.5% or less.

14. The panel according to claim 10, wherein
the microstructure of the steel sheet in the flat part comprises, by area %,
ferrite: 75 to 95%,
martensite: 5 to 25%, and
at least one of bainite, pearlite, and retained austenite: 0 to 10% in total,
a mean grain interval of martensite is 2.5 μm or less, and
a standard deviation in an area ratio of martensite in a direction vertical to a rolling direction and sheet thickness direction is 1.5% or less.

15. The panel according to claim 7, wherein a thickness of the flat part is 0.2 to 0.8 mm.

16. The panel according to claim 8, wherein a thickness of the flat part is 0.2 to 0.8 mm.

17. The panel according to claim 9, wherein a thickness of the flat part is 0.2 to 0.8 mm.

18. The panel according to claim 10, wherein a thickness of the flat part is 0.2 to 0.8 mm.

19. The panel according to claim 11, wherein a thickness of the flat part is 0.2 to 0.8 mm.

20. The panel according to claim 12, wherein a thickness of the flat part is 0.2 to 0.8 mm.

21. The panel according to claim 13, wherein a thickness of the flat part is 0.2 to 0.8 mm.

22. The panel according to claim 14, wherein a thickness of the flat part is 0.2 to 0.8 mm.

23. The panel according to claim 7, wherein the panel has a tensile strength of 400 to 900 MPa.

24. The panel according to claim 8, wherein the panel has a tensile strength of 400 to 900 MPa.

25. The panel according to claim 9, wherein the panel has a tensile strength of 400 to 900 MPa.

26. The panel according to claim 10, wherein the panel has a tensile strength of 400 to 900 MPa.
